(19) United States
(12) Patent Application Publication
(10) Pub. No.: US 2024/0257018 A1
(43) Pub. Date: Aug. 1, 2024

(54) INSIGHT VALUE ASSESSMENTS USING POST-INSIGHT FEEDBACK

(71) Applicant: Dell Products L.P., Round Rock, TX (US)

(72) Inventors: Stephen James Todd, North Andover, MA (US); Eloy Francisco Macha, Crowley, TX (US); David Edward Frattura, Stamford, CT (US); Robert Anthony Lincourt, JR., Franklin, MA (US)

(21) Appl. No.: 18/162,277

(22) Filed: Jan. 31, 2023

(51) Int. Cl. G06Q 10/0637

(52) U.S. Cl. CPC G06Q 10/06375

(57) ABSTRACT

A method and system for insight value assessments using post-insight feedback. Any insight may be defined as a finding (or more broadly, as useful knowledge) gained through data analytics or, more precisely, through the discovery of patterns and/or relationships amongst any given assortment of data/information. Further, the re-use (or plagiarism) of any insight, within and/or outside an organization, is commonplace. For insight inference models dependent on diverse information to achieve high inference accuracy, the re-use of any same insight, across numerous data/information assets, tends to create bias(es) affecting the inferred insight(s). In addition, the insight value for any insight is often lost once said insight leaves a controlled ecosystem. Embodiments disclosed herein, accordingly, implement a framework through which a lifecycle of any insight may be traced in order to address at least the aforementioned issues.

### BACKGROUND

Organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence.

### SUMMARY

In general, in one aspect, embodiments disclosed herein relate to a method for assessing insight values. The method includes: examining a data source to identify a new asset from a collection of assets maintained on the data source; ingesting the new asset to obtain an asset content of the new asset; identifying, from the asset content, an asset content component including a digital tracking tag; identifying an insight based on the digital tracking tag, wherein the asset content component represents a re-used traceable insight derived from the insight; making a determination that the re-used traceable insight includes a modification that had been applied to the insight during a re-use of the insight; contacting, based on the determination, an author of the new asset to obtain insight modification information concerning the modification; and assessing an insight value of the insight at least based on the insight modification information.

In general, in one aspect, embodiments disclosed herein relate to a non-transitory computer readable medium (CRM). The non-transitory CRM includes computer readable program code, which when executed by a computer processor, enables the computer processor to perform a method for assessing insight values. The method includes: examining a data source to identify a new asset from a collection of assets maintained on the data source; ingesting the new asset to obtain an asset content of the new asset; identifying, from the asset content, an asset content component including a digital tracking tag; identifying an insight based on the digital tracking tag, wherein the asset content component represents a re-used traceable insight derived from the insight; making a determination that the re-used traceable insight includes a modification that had been applied to the insight during a re-use of the insight; contacting, based on the determination, an author of the new asset to obtain insight modification information concerning the modification; and assessing an insight value of the insight at least based on the insight modification information.

In general, in one aspect, embodiments disclosed herein relate to a system. The system includes: an insight service including a computer processor configured to perform a method assessing insight values. The method includes: examining a data source to identify a new asset from a collection of assets maintained on the data source; ingesting the new asset to obtain an asset content of the new asset; identifying, from the asset content, an asset content component including a digital tracking tag; identifying an insight based on the digital tracking tag, wherein the asset content component represents a re-used traceable insight derived from the insight; making a determination that the re-used traceable insight includes a modification that had been applied to the insight during a re-use of the insight; contacting, based on the determination, an author of the new asset to obtain insight modification information concerning the modification; and assessing an insight value of the insight at least based on the insight modification information.

Other aspects disclosed herein will be apparent from the following description and the appended claims.

### BRIEF DESCRIPTION OF DRAWINGS

FIG. 1A shows a system in accordance with one or more embodiments disclosed herein.

FIG. 1B shows a client device in accordance with one or more embodiments disclosed herein.

FIG. 2A shows an example connected graph in accordance with one or more embodiments disclosed herein.

FIGS. 2B-2D show example k-partite connected graphs in accordance with one or more embodiments disclosed herein.

FIGS. 3A-3D show flowcharts describing a method for insight value assessments using post-insight feedback in accordance with one or more embodiments disclosed herein.

FIG. 4 shows an example computing system in accordance with one or more embodiments disclosed herein.

FIGS. 5A-5P show an example scenario in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding disclosed herein. However, it will be apparent to one of ordinary skill in the art that the embodiments disclosed herein may be practiced without these specific details. In other instances, well-known features have not been described in detail to avoid unnecessarily complicating the description.

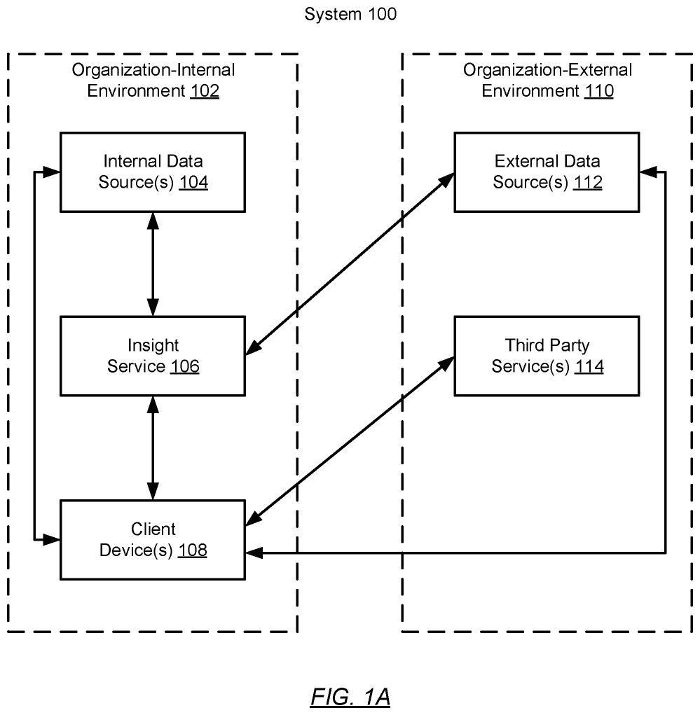

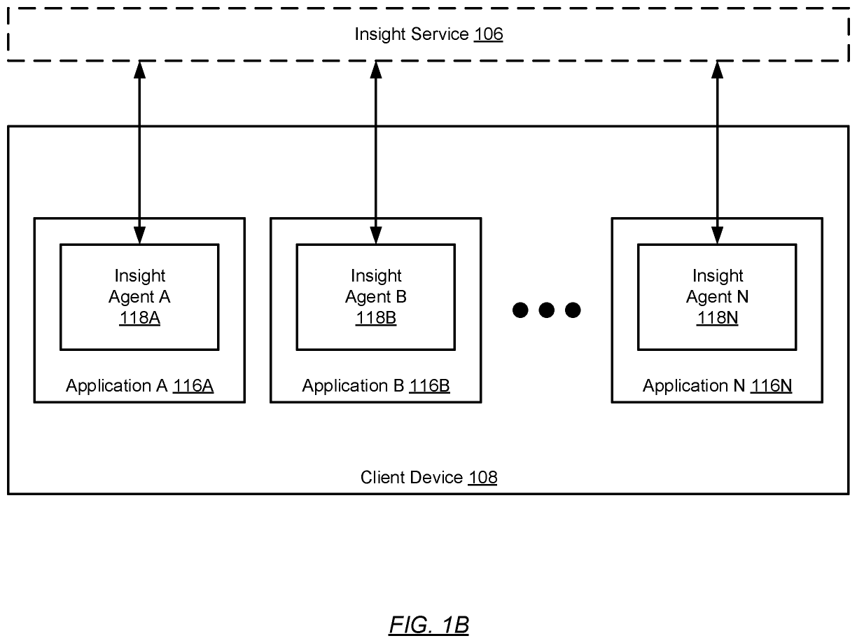

In the following description of FIGS. 1A-5P, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments disclosed herein relate to insight value assessments using post-insight feedback. Any insight may be defined as a finding (or more broadly, as useful knowledge) gained through data analytics or, more precisely, through the discovery of patterns and/or relationships amongst any given assortment of data/information. Further, the re-use (or plagiarism) of any insight, within and/or outside an organization, is commonplace. For insight inference models dependent on diverse information to achieve high inference accuracy, the re-use of any same insight, across numerous data/information assets, tends to create bias(es) affecting the inferred insight(s). In addition, the insight value for any insight is often lost once said insight leaves a controlled ecosystem. Embodiments disclosed herein, accordingly, implement a framework through which a lifecycle of any insight may be traced in order to address at least the aforementioned issues.

FIG. 1A shows a system in accordance with one or more embodiments disclosed herein. The system (100) may include an organization-internal environment (102) and an organization-external environment (110). Each of these system (100) components is described below.

In one or many embodiment(s) disclosed herein, the organization-internal environment (102) may represent any digital (e.g., information technology (IT)) ecosystem belonging to, and thus managed by, an organization. Examples of said organization may include, but are not limited to, a business/commercial entity, a higher education school, a government agency, and a research institute. The organization-internal environment (102), accordingly, may at least reference one or more data centers of which the organization is the proprietor. Further, the organization-internal environment (102) may include one or more internal data sources (104), an insight service (106), and one or more client devices (108). Each of these organization-internal environment (102) subcomponents may or may not be co-located, and thus reside and/or operate, in the same physical or geographical space. Moreover, each of these organization-internal environment (102) subcomponents is described below.

In one or many embodiment(s) disclosed herein, an internal data source (104) may represent any data source belonging to, and thus managed by, the above-mentioned organization. A data source, in turn, may generally refer to a location where data or information (also referred to herein as one or more assets) resides. An asset, accordingly, may be exemplified through structured data/information (e.g., tabular data/information or a dataset) or through unstructured data/information (e.g., text, an image, audio, a video, an animation, multimedia, etc.). Furthermore, any internal data source (104), more specially, may refer to a location that stores at least a portion of the asset(s) generated, modified, or otherwise interacted with, solely by entities (e.g., the insight service (106) and/or the client device(s) (108)) within the organization-internal environment (102). Entities outside the organization-internal environment may not be permitted to access any internal data source (104) and, therefore, may not be permitted to access any asset(s) maintained therein.

Moreover, in one or many embodiment(s) disclosed herein, any internal data source (104) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, the insight service (106) may represent information technology infrastructure configured for digitally-assisted organization strategy. In brief, organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence. An insight, in turn, may be defined as a finding (or more broadly, as useful knowledge) gained through data analytics or, more precisely, through the discovery of patterns and/or relationships amongst an assortment of data/information (e.g., assets). The insight service (106), accordingly, may employ artificial intelligence to ingest assets maintained across various data sources (e.g., one or more internal data sources (104) and/or one or more external data sources (112)) and, subsequently, derive or infer insights therefrom that are supportive of an organization strategy for an organization.

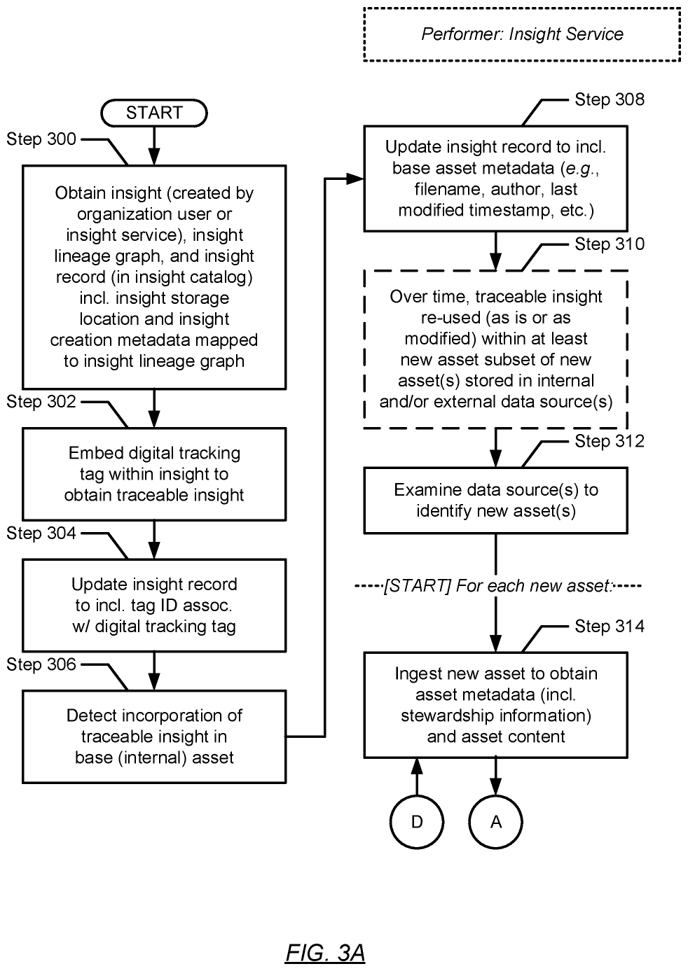

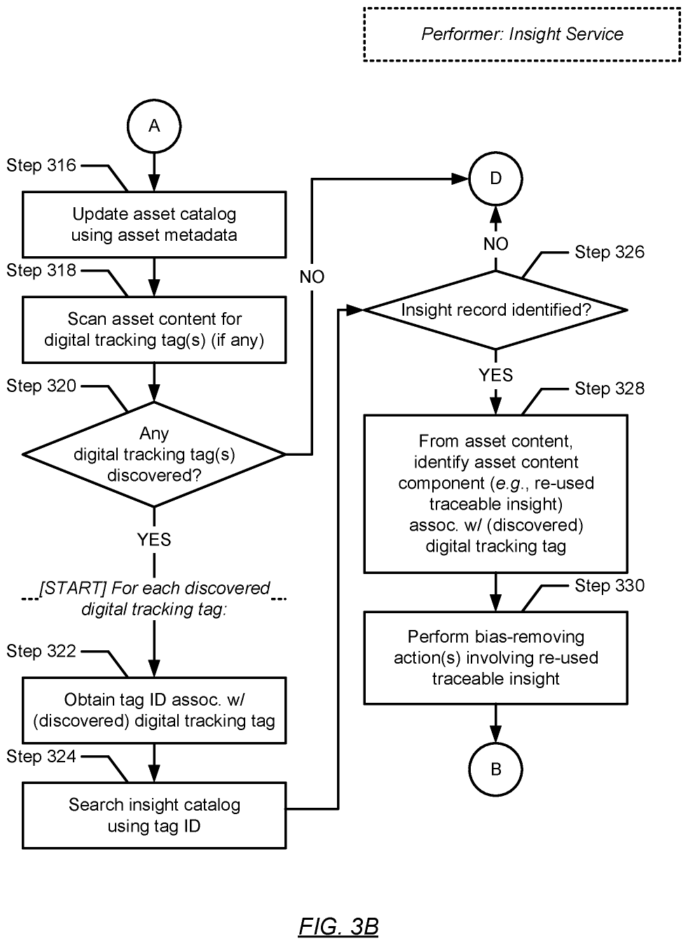

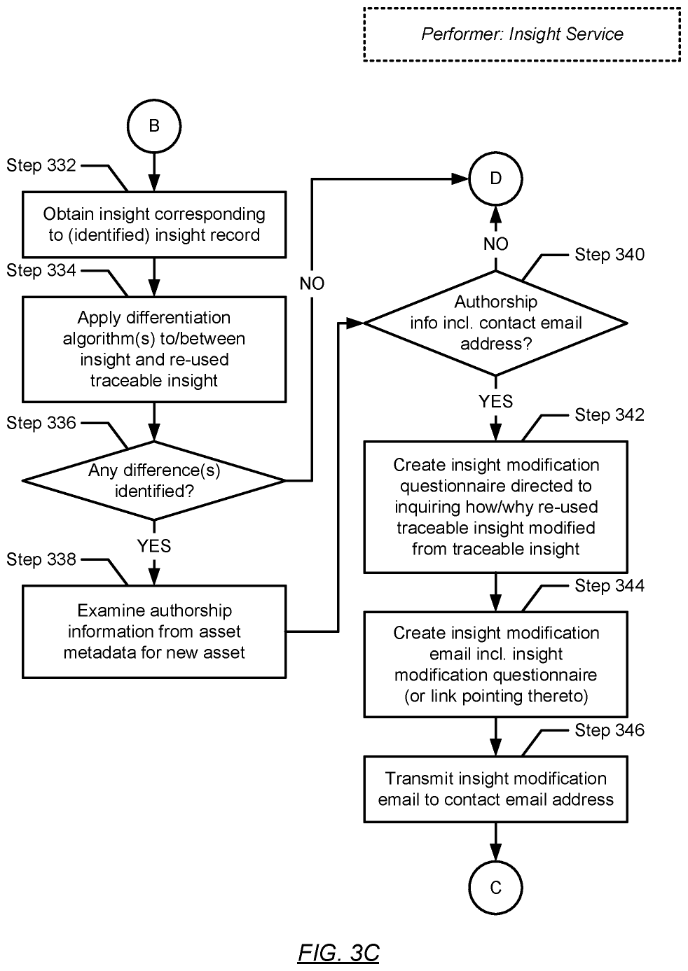

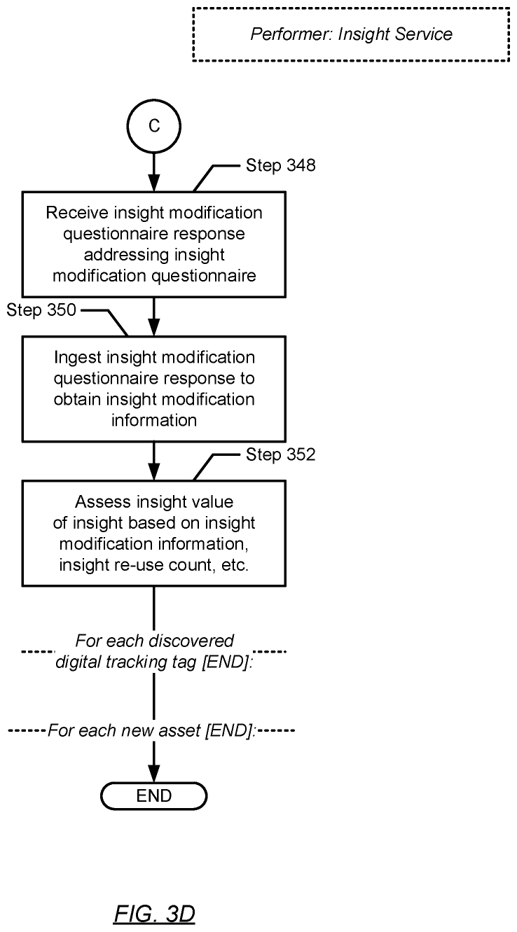

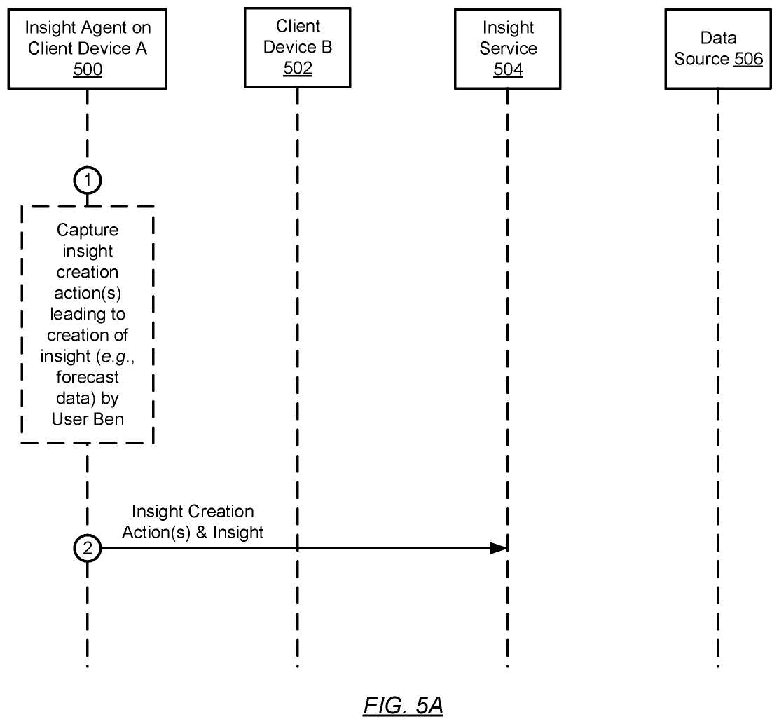

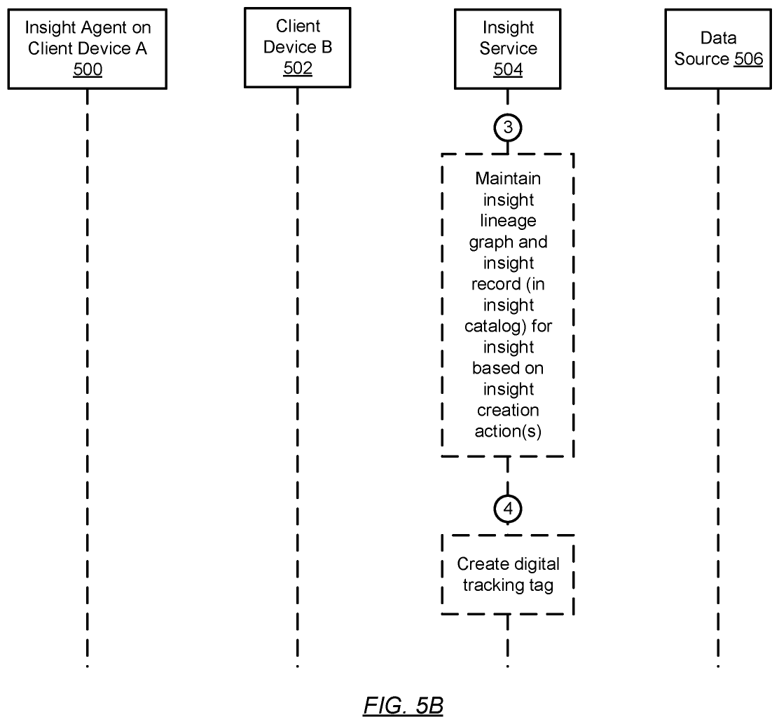

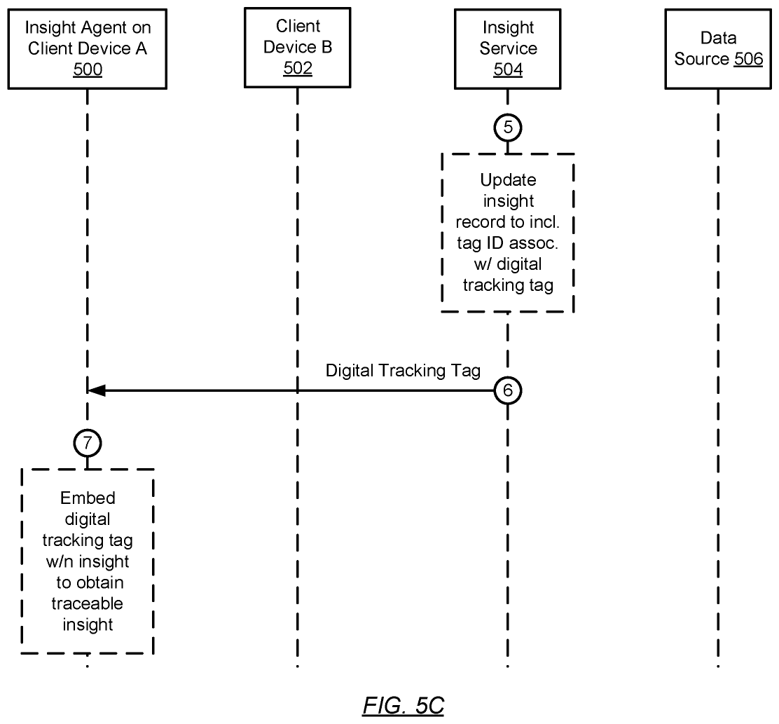

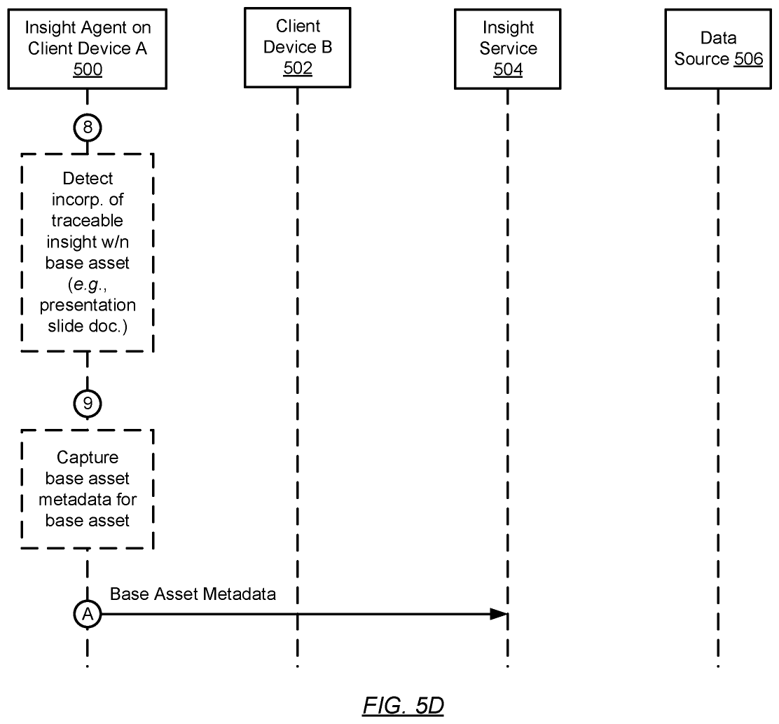

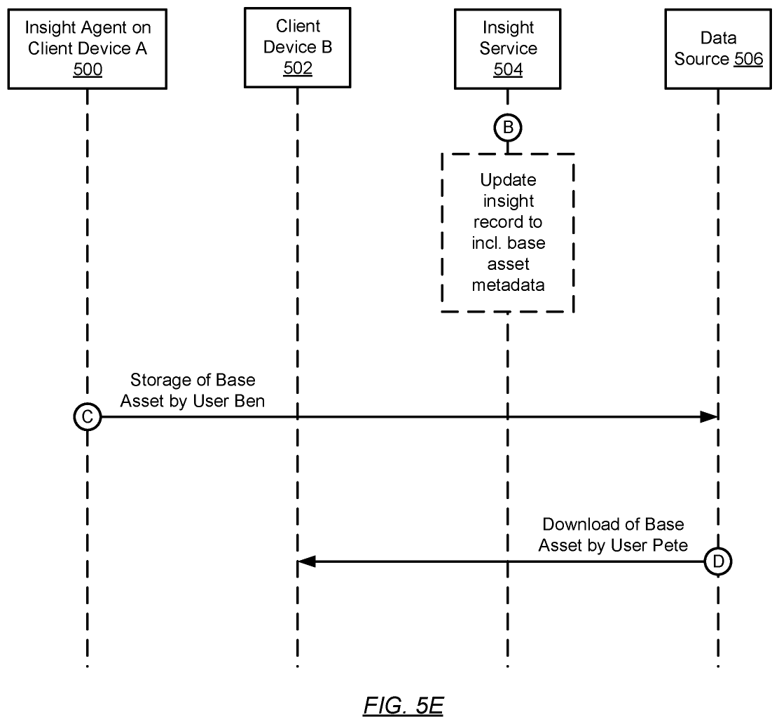

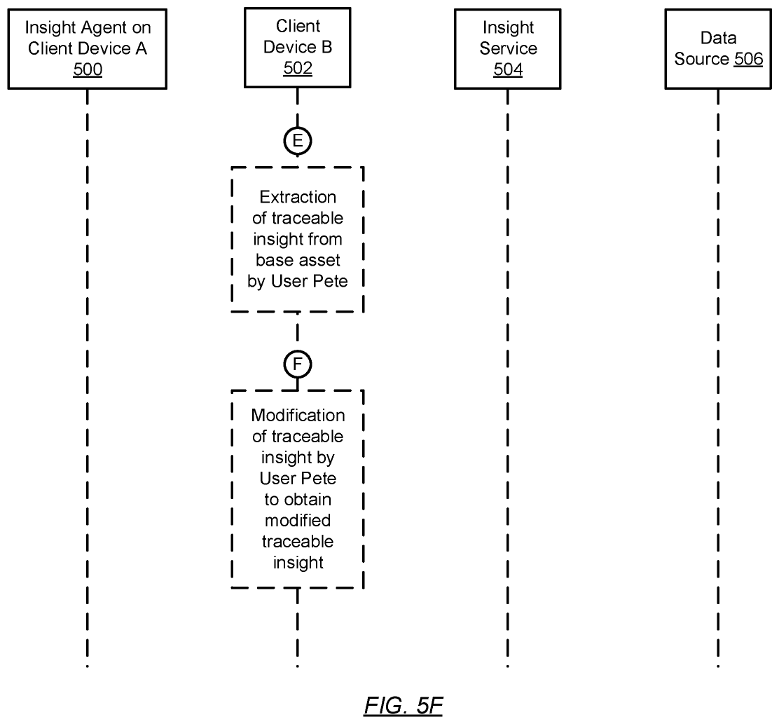

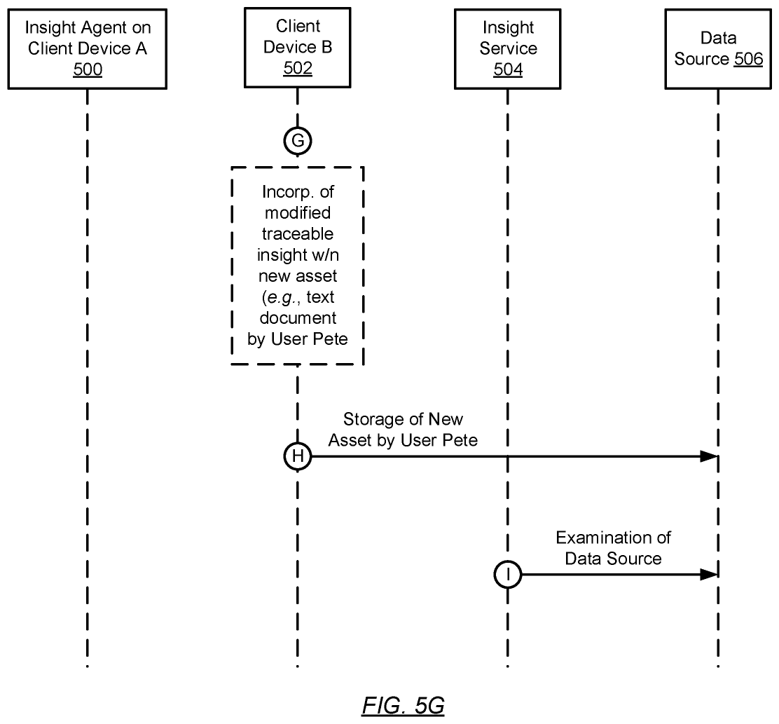

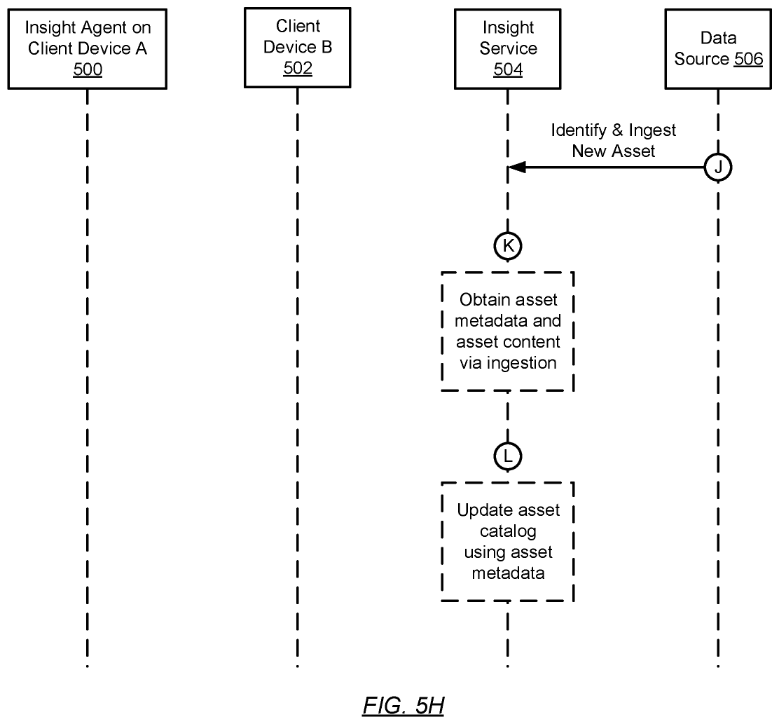

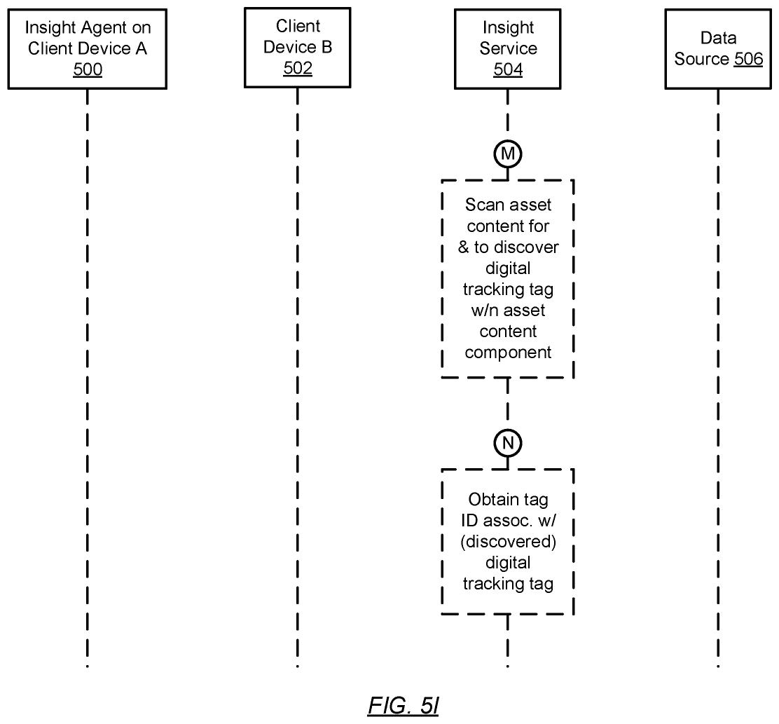

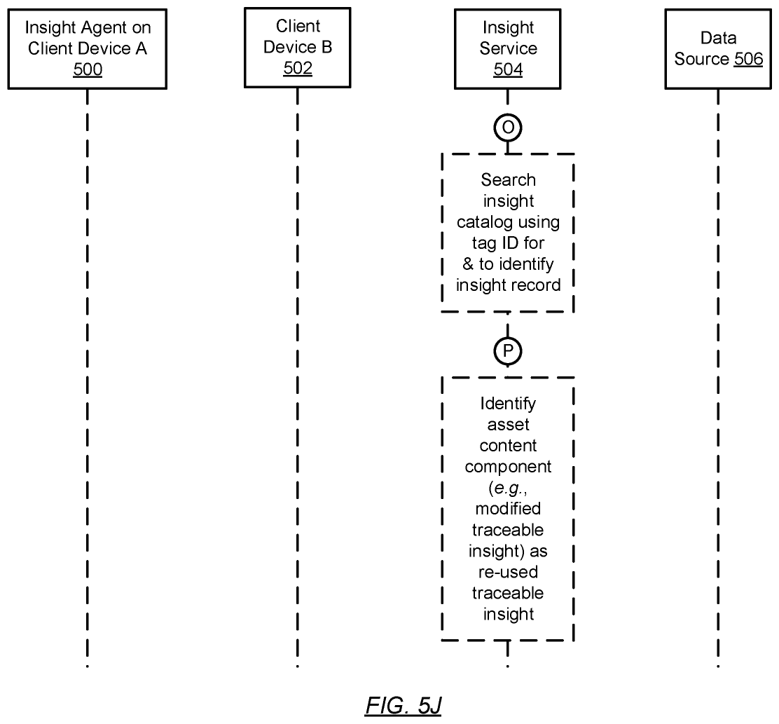

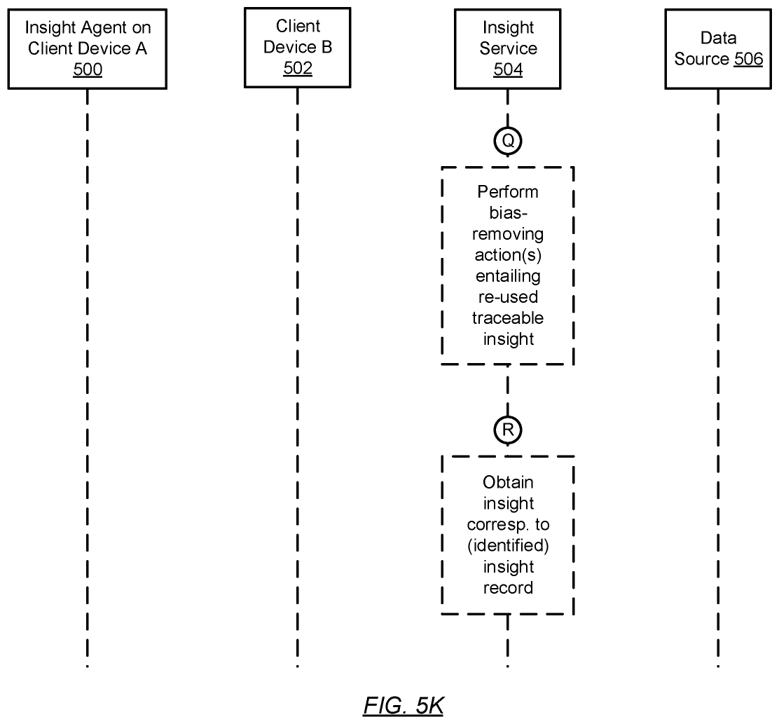

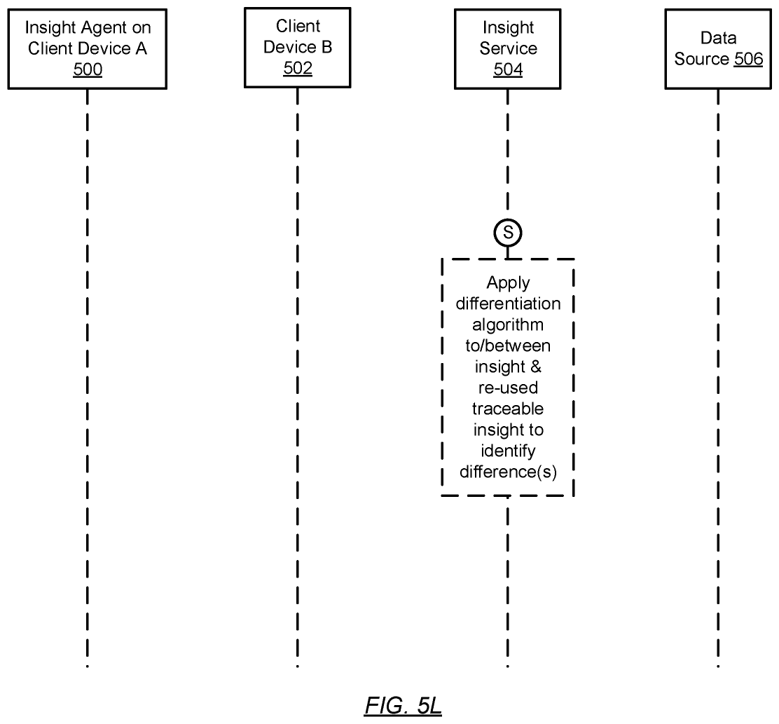

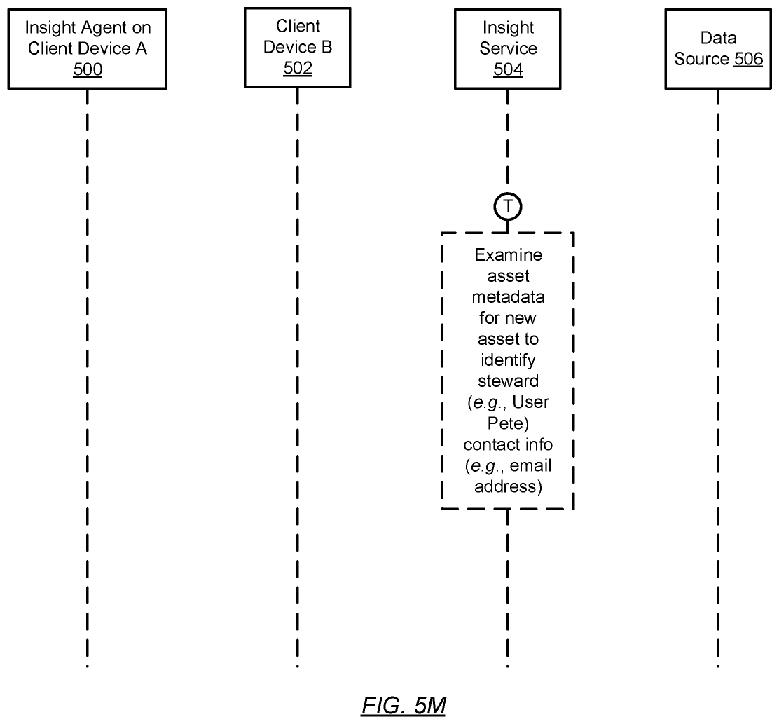

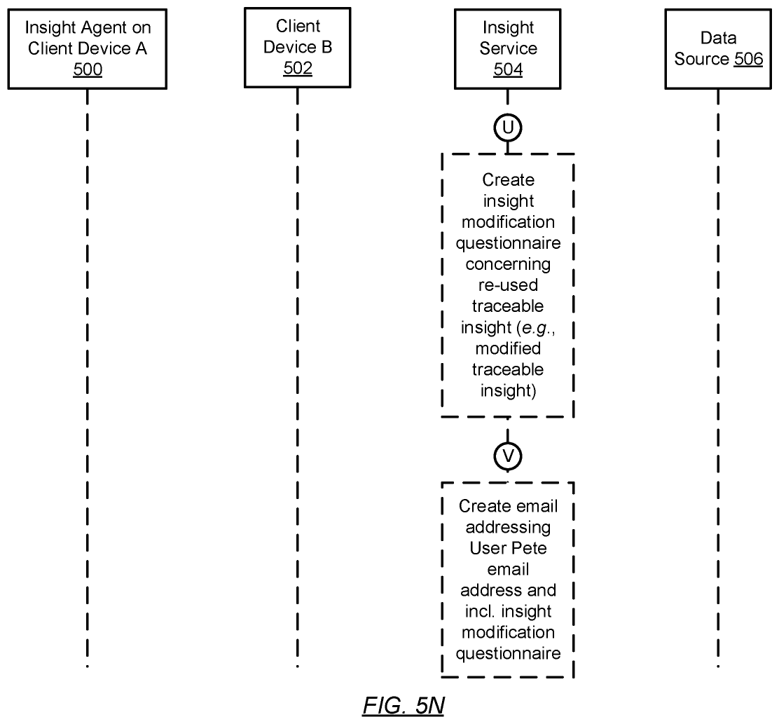

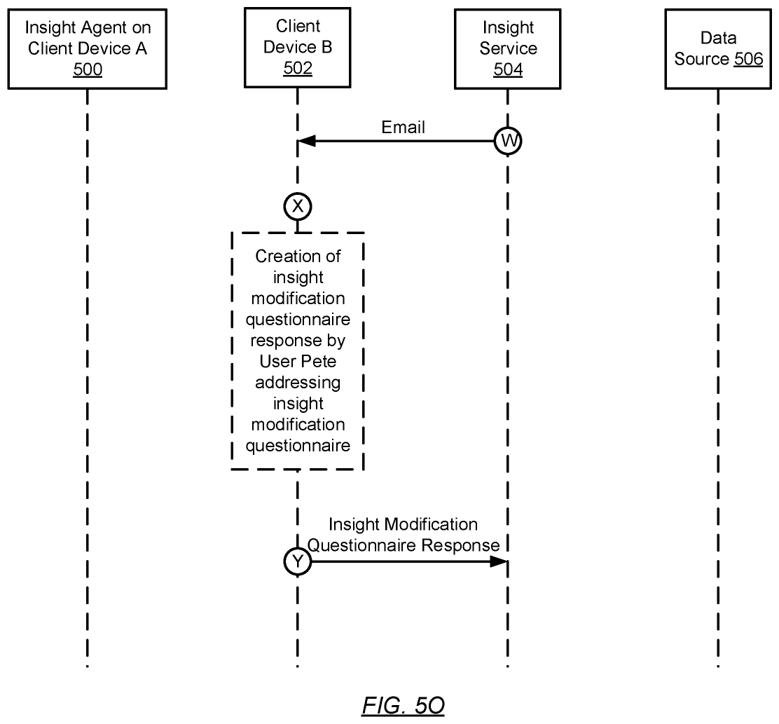

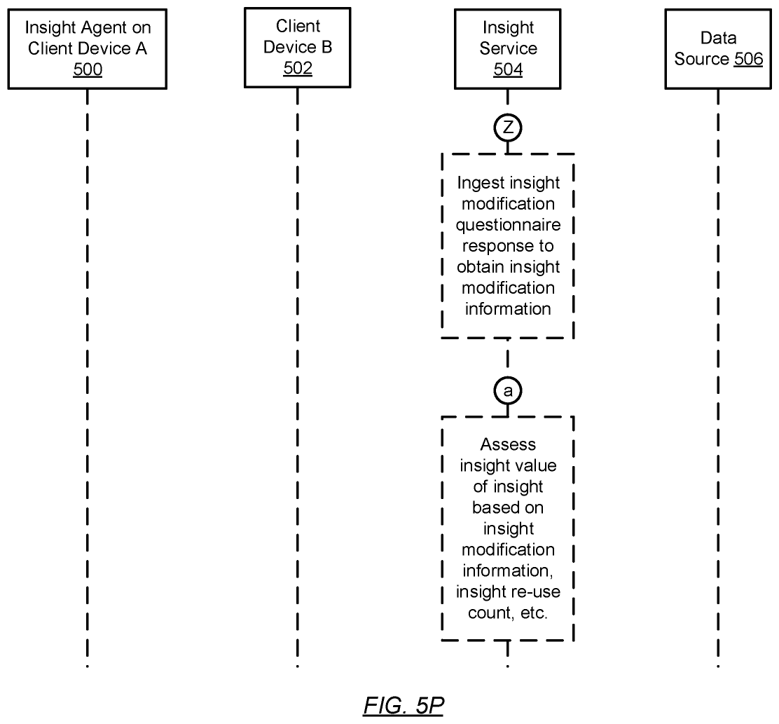

In one or many embodiment(s) disclosed herein, the insight service (106) may be configured with various capabilities or functionalities directed to digitally-assisted organization strategy. Said capabilities/functionalities may include: insight value assessment using post-insight feedback, as described in FIGS. 3A-3D as well as exemplified in FIGS. 5A-5P, below. Further, the insight service (106) may perform other capabilities/functionalities without departing from the scope disclosed herein.

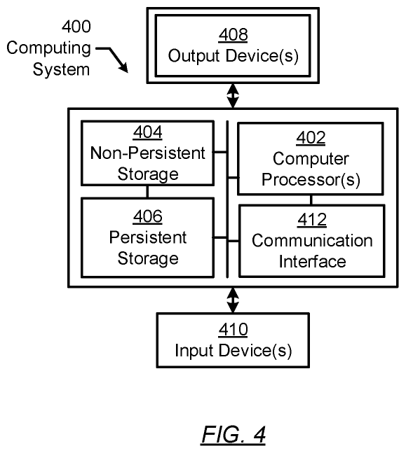

In one or many embodiment(s) disclosed herein, the insight service (106) may be implemented through on-premises infrastructure, cloud computing infrastructure, or any hybrid infrastructure thereof. The insight service (106), accordingly, may be implemented using one or more network servers (not shown), where each network server may represent a physical or a virtual network server. Additionally, or alternatively, the insight service (106) may be implemented using one or more computing systems each similar to the example computing system shown and described with respect to FIG. 4, below.

In one or many embodiment(s) disclosed herein, a client device (108) may represent any physical appliance or computing system operated by one or more organization users and configured to receive, generate, process, store, and/or transmit data/information (e.g., assets), as well as to provide an environment in which one or more computer programs (e.g., applications, insight agents, etc.) may execute thereon. An organization user, briefly, may refer to any individual whom is affiliated with, and fulfills one or more roles pertaining to, the organization that serves as the proprietor of the organization-internal environment (102). Further, in providing an execution environment for any computer programs, a client device (108) may include and allocate various resources (e.g., computer processors, memory, storage, virtualization, network bandwidth, etc.), as needed, to the computer programs and the tasks (or processes) instantiated thereby. Examples of a client device (108) may include, but are not limited to, a desktop computer, a laptop computer, a tablet computer, a smartphone, or any other computing system similar to the example computing system shown and described with respect to FIG. 4, below. Moreover, any client device (108) is described in further detail through FIG. 1B, below.

In one or many embodiment(s) disclosed herein, the organization-external environment (110) may represent any number of digital (e.g., IT) ecosystems not belonging to, and thus not managed by, an/the organization serving as the proprietor of the organization-internal environment (102). The organization-external environment (110), accordingly, may at least reference any public networks including any respective service(s) and data/information (e.g., assets). Further, the organization-external environment (110) may include one or more external data sources (112) and one or more third-party services (114). Each of these organization-external environment (110) subcomponents may or may not be co-located, and thus reside and/or operate, in the same physical or geographical space. Moreover, each of these organization-external environment (110) subcomponents is described below.

In one or many embodiment(s) disclosed herein, an external data source (112) may represent any data source (described above) not belonging to, and thus not managed by, an/the organization serving as the proprietor of the organization-internal environment (102). Any external data source (112), more specially, may refer to a location that stores at least a portion of the asset(s) found across any public networks. Further, depending on their respective access permissions, entities within the organization-internal environment (102), as well as those throughout the organization-external environment (110), may or may not be permitted to access any external data source (104) and, therefore, may or may not be permitted to access any asset(s) maintained therein.

Moreover, in one or many embodiment(s) disclosed herein, any external data source (112) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, a third party service (114) may represent information technology infrastructure configured for any number of purposes and/or applications. A third party, whom may implement and manage one or more third party services (114), may refer to an individual, a group of individuals, or another organization (i.e., not the organization serving as the proprietor of the organization-internal environment (102)) that serves as the proprietor of said third party service(s) (114). By way of an example, one such third party service (114), as disclosed herein may be exemplified by an automated machine learning (ML) service. A purpose of the automated ML service may be directed to automating the selection, composition, and parameterization of ML models. That is, more simply, the automated ML service may be configured to automatically identify one or more optimal ML algorithms from which one or more ML models may be constructed and fit to a submitted dataset in order to best achieve any given set of tasks. Further, any third party service (114) is not limited to the aforementioned specific example.

In one or many embodiment(s) disclosed herein, any third party service (114) may be implemented through on-premises infrastructure, cloud computing infrastructure, or any hybrid infrastructure thereof. Any third party service (114), accordingly, may be implemented using one or more network servers (not shown), where each network server may represent a physical or a virtual network server. Additionally, or alternatively, any third party service (114) may be implemented using one or more computing systems each similar to the example computing system shown and described with respect to FIG. 4, below.

In one or many embodiment(s) disclosed herein, the above-mentioned system (100) components, and their respective subcomponents, may communicate with one another through a network (not shown) (e.g., a local area network (LAN), a wide area network (WAN) such as the Internet, a mobile network, any other communication network type, or a combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components and their respective subcomponents. Moreover, in communicating with one another, the above-mentioned system (100) components, and their respective subcomponents, may employ any combination of existing wired and/or wireless communication protocols.

While FIG. 1A shows a configuration of components and/or subcomponents, other system (100) configurations may be used without departing from the scope disclosed herein.

FIG. 1B shows a client device in accordance with one or more embodiments disclosed herein. The client device (108) (described above as well) (see e.g., FIG. 1A) may host or include one or more applications (116A-116N). Each application (116A-116N), in turn, may host or include an insight agent (118A-118N). Each of these client device (108) subcomponents is described below.

In one or many embodiment(s) disclosed herein, an application (116A-116N) (also referred to herein as a software application or program) may represent a computer program, or a collection of computer instructions, configured to perform one or more specific functions. Broadly, examples of said specific function(s) may include, but are not limited to, receiving, generating and/or modifying, processing and/or analyzing, storing or deleting, and transmitting data/information (e.g., assets) (or at least portions thereof). That is, said specific function(s) may generally entail one or more interactions with data/information either maintained locally on the client device (108) or remotely across one or more data sources. Examples of an application (116A-116N) may include a word processor, a spreadsheet editor, a presentation editor, a database manager, a graphics renderer, a video editor, an audio editor, a web browser, a collaboration tool or platform, and an electronic mail (or email) client. Any application (116A-116N), further, is not limited to the aforementioned specific examples.

In one or many embodiment(s) disclosed herein, any application (116A-116N) may be employed by one or more organization users, which may be operating the client device (108), to achieve one or more tasks, at least in part, contingent on the specific function(s) that the application (116A-116N) may be configured to perform. Said task(s) may or may not be directed to supporting and/or achieving any short-term and/or long-term goal(s) outlined by an/the organization with which the organization user(s) may be affiliated.

In one or many embodiment(s) disclosed herein, an insight agent (118A-118N) may represent a computer program, or a collection of computer instructions, configured to perform any number of tasks in support, or as extensions, of the capabilities or functionalities of the insight service (106) (described above) (see e.g., FIG. 1A). With respect to their assigned application (116A-116N), examples of said tasks, which may be carried out by a given insight agent (118A-118N), may include: detecting an initiation of their assigned application (116A-116N) by the organization user(s) operating the client device (108); monitoring any engagement (or interaction), by the organization user(s), with their assigned application (116A-116N) following the detected initiation thereof; identifying certain engagement/interaction actions, performed by the organization user(s), based on said engagement/interaction monitoring; executing any number of procedures or algorithms, relevant to one or more insight service (106) capabilities/functionalities, in response to one or more of the identified certain engagement/interaction actions; providing periodic and/or on-demand telemetry to the insight service (106), where said telemetry may include, for example, data/information requiring processing or analysis to be performed on/by the insight service (106); and receive periodic and/or on-demand updates (and/or instructions) from the insight service (106). Further, the tasks carried out by any insight agent (118A-118N) are not limited to the aforementioned specific examples.

While FIG. 1B shows a configuration of components and/or subcomponents, other client device (108) configurations may be used without departing from the scope disclosed herein. For example, in one or many embodiment(s) disclosed herein, not all of the application(s) (116A-116N), executing on the client device (108), may host or include an insight agent (118A-118N). That is, in said embodiment(s), an insight agent (118A-118N) may not be assigned to or associated with any of at least a subset of the application(s) (116A-116N) installed on the client device (108).

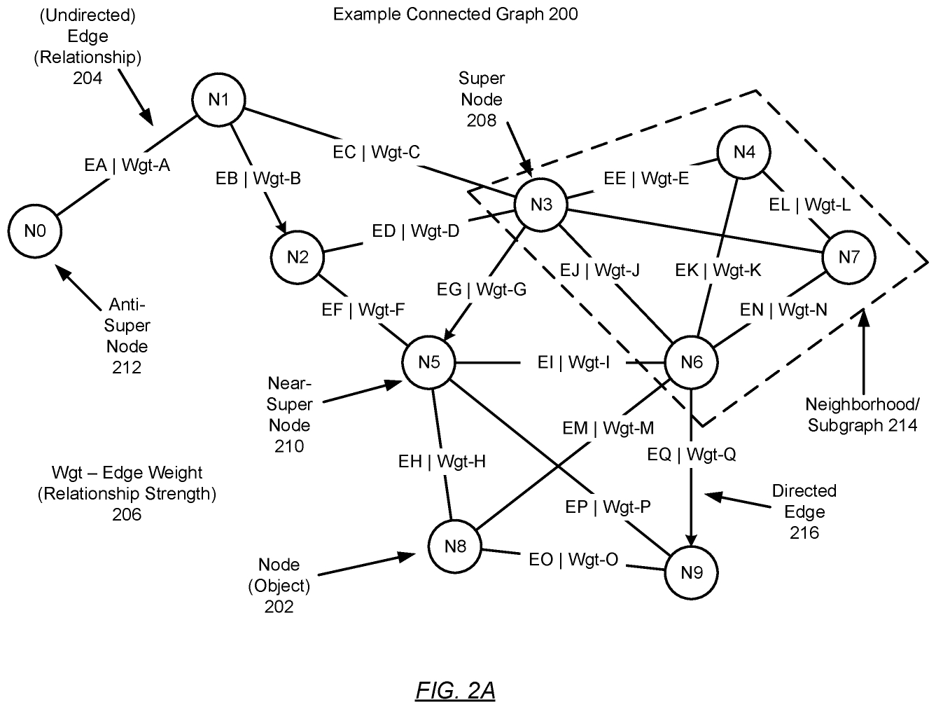

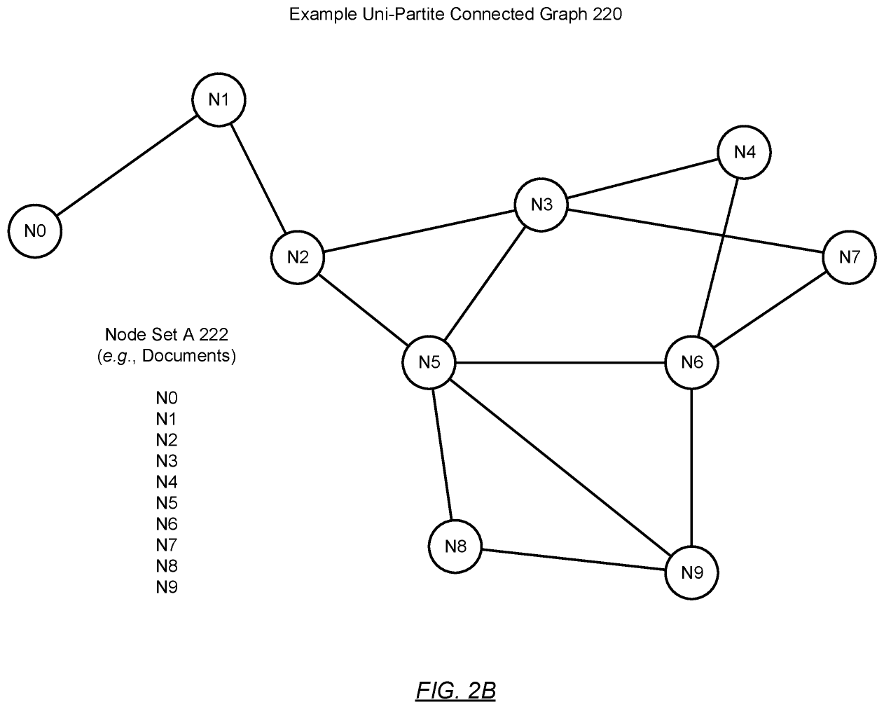

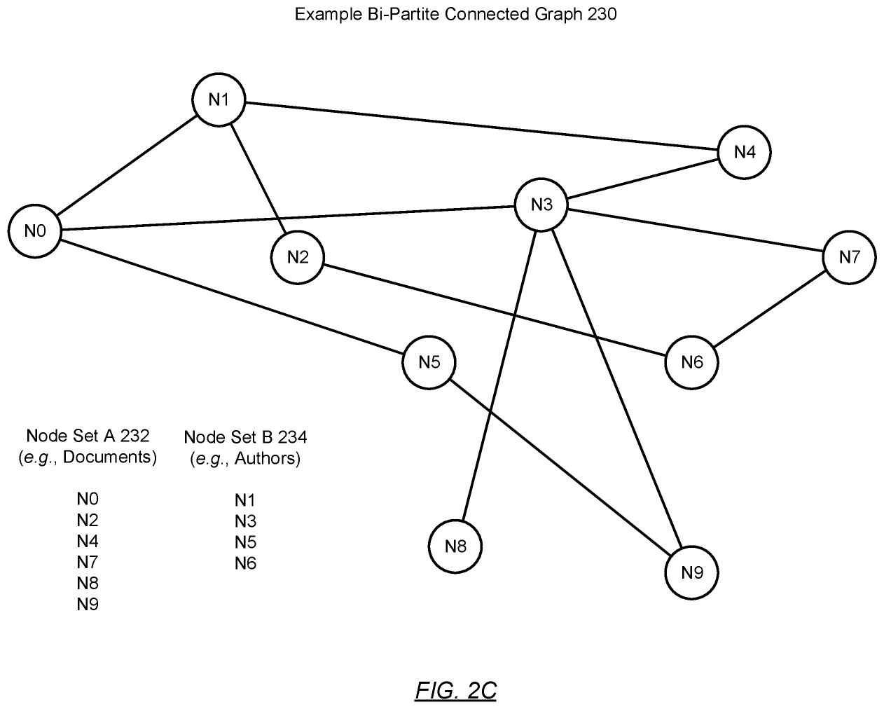

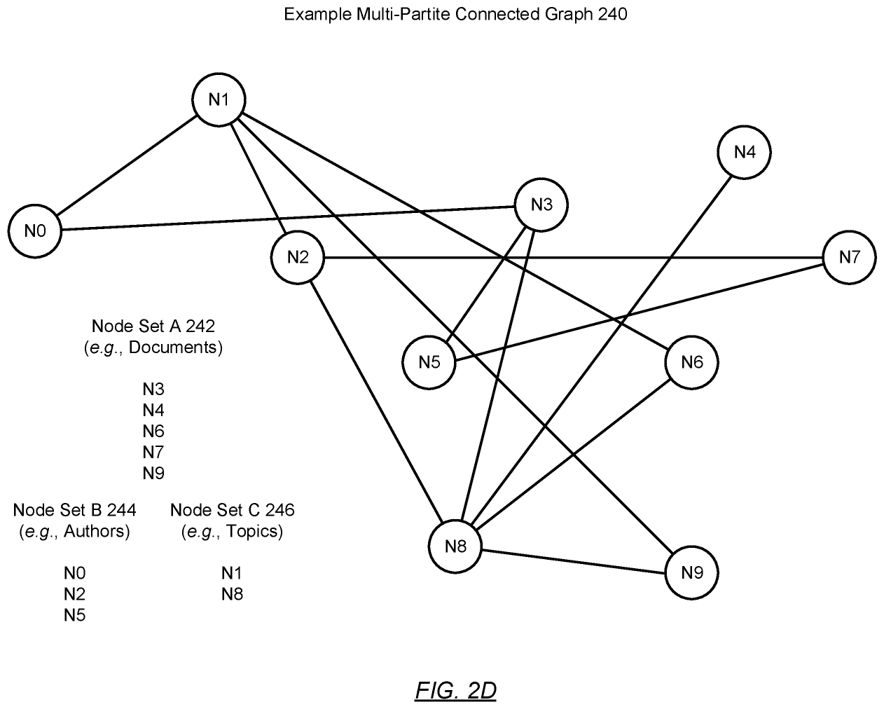

FIG. 2A shows an example connected graph in accordance with one or more embodiments disclosed herein. A connected graph (200), as disclosed herein, may refer to a set of nodes (202) (denoted in the example by the circles labeled N0, N1, N2, . . . , N9) interconnected by a set of edges (204, 216) (denoted in the example by the lines labeled EA, EB, EC, . . . , EQ between pairs of nodes). Each node (202) may represent or correspond to an object (e.g., a catalog entry, a record, specific data/information, a person, etc.) whereas each edge (204, 216), between or connecting any pair of nodes, may represent or correspond to a relationship, or relationships, associating the objects mapped to the pair of nodes. A connected graph (200), accordingly, may reference a data structure that reflects associations amongst any number, or a collection, of objects.

In one or many embodiment(s) disclosed herein, each node (202), in a connected graph (200), may also be referred to herein, and thus may serve, as an endpoint (of a pair of endpoints) of/to at least one edge (204). Further, based on a number of edges connected thereto, any node (202), in a connected graph (200), may be designated or identified as a super node (208), a near-super node (210), or an anti-super node (212). A super node (208) may reference any node where the number of edges, connected thereto, meets or exceeds a (high) threshold number of edges (e.g., six (6) edges). A near-super node (210), meanwhile, may reference any node where the number of edges, connected thereto, meets or exceeds a first (high) threshold number of edges (e.g., five (5) edges) yet lies below a second (higher) threshold number of edges (e.g., six (6) edges), where said second threshold number of edges defines the criterion for designating/identifying a super node (208). Lastly, an anti-super node (212) may reference any node where the number of edges, connected thereto, lies below a (low) threshold number of edges (e.g., two (2) edges).

In one or many embodiment(s) disclosed herein, each edge (204, 216), in a connected graph (200), may either be designated or identified as an undirected edge (204) or, conversely, as a directed edge (216). An undirected edge (204) may reference any edge specifying a bidirectional relationship between objects mapped to the pair of endpoints (i.e., pair of nodes (202)) connected by the edge. A directed edge (216), on the other hand, may reference any edge specifying a unidirectional relationship between objects mapped to the pair of endpoints connected by the edge.

In one or many embodiment(s) disclosed herein, each edge (204, 216), in a connected graph (200), may be associated with or assigned an edge weight (206) (denoted in the example by the labels Wgt-A, Wgt-B, Wgt-C, . . . . , Wgt-Q). An edge weight (206), of a given edge (204, 216), may reflect a strength of the relationship(s) represented by the given edge (204, 216). Further, any edge weight (206) may be expressed as or through a positive numerical value within a predefined spectrum or range of positive numerical values (e.g., 0.1 to 1.0, 1 to 100, etc.). Moreover, across the said predefined spectrum/range of positive numerical values, higher positive numerical values may reflect stronger relationships, while lower positive numerical values may alternatively reflect weaker relationships.

In one or many embodiment(s) disclosed herein, based on an edge weight (206) associated with or assigned to an edge (204, 216) connected thereto, any node (202), in a connected graph (200), may be designated or identified as a strong adjacent node (not shown) or a weak adjacent node (not shown) with respect to the other endpoint of (i.e., the other node connected to the node (202) through) the edge (204, 216). That is, a strong adjacent node may reference any node of a pair of nodes connected by an edge, where an edge weight of the edge meets or exceeds a (high) edge weight threshold. Alternatively, a weak adjacent node may reference any node of a pair of nodes connected by an edge, where an edge weight of the edge lies below a (low) edge weight threshold.

In one or many embodiment(s) disclosed herein, a connected graph (200) may include one or more subgraphs (214) (also referred to as neighborhoods). A subgraph (214) may refer to a smaller connected graph found within a (larger) connected graph (200). A subgraph (214), accordingly, may include a node subset of the set of nodes (202), and an edge subset of the set of edges (204, 216), that form a connected graph (200), where the edge subset interconnects the node subset.

While FIG. 2A shows a configuration of components and/or subcomponents, other connected graph (200) configurations may be used without departing from the scope disclosed herein.

FIGS. 2B-2D show example k-partite connected graphs in accordance with one or more embodiments disclosed herein. Generally, any k-partite connected graph may represent a connected graph (described above) (see e.g., FIG. 2A) that encompasses k independent sets of nodes and a set of edges interconnecting (and thus defining relationships between) pairs of nodes: (a) both belonging to the same, single independent set of nodes in any (k=1)-partite connected graph; or (b) each belonging to a different independent set of nodes in any (k>1)-partite connected graph. Further, any k-partite connected graph, as disclosed herein, may fall into one of three possible classifications: (a) a uni-partite connected graph, where k=1; (b) a bi-partite connected graph, where k=2; or (c) a multi-partite connected graph, where k≥3.

Turning to FIG. 2B, an example uni-partite connected graph (220) is depicted. The uni-partite connected graph (220) includes one (k=1) independent set of nodes—i.e., a node set (222), which collectively maps or belongs to a single object class (e.g., documents).

Further, in the example, the node set is denoted by the circles labeled NO, N1, N2, . . . , N9. Each said circle, in the node set (222), subsequently denotes a node that represents or corresponds to a given object (e.g., a document) in a collection of objects (e.g., a group of documents) of the same object class (e.g., documents).

Moreover, the uni-partite connected graph (220) additionally includes a set of edges (denoted in the example by the lines interconnecting pairs of nodes, where the first and second nodes in a given node pair belongs to the node set (222)). Each edge, in the example, thus reflects a relationship, or relationships, between any two nodes of the node set (222) (and, by association, any two objects of the same object class) directly connected via the edge.

Turning to FIG. 2C, an example bi-partite connected graph (230) is depicted. The bi-partite connected graph (230) includes two (k=2) independent sets of nodes—i.e., a first node set (232) and a second node set (234), where the former collectively maps or belongs to a first object class (e.g., documents) whereas the latter collectively maps or belongs to a second object class (e.g., authors).

Further, in the example, the first node set (232) is denoted by the circles labeled NO, N2, N4, N7, N8, and N9, while the second node set (234) is denoted by the circles labeled N1, N3, N5, and N6. Each circle, in the first node set (232), subsequently denotes a node that represents or corresponds to a given first object (e.g., a document) in a collection of first objects (e.g., a group of documents) of the first object class (e.g., documents). Meanwhile, each circle, in the second node set (234), subsequently denotes a node that represents or corresponds to a given second object (e.g., an author) in a collection of second objects (e.g., a group of authors) of the second object class (e.g., authors).

Moreover, the bi-partite connected graph (230) additionally includes a set of edges (denoted in the example by the lines interconnecting pairs of nodes, where a first node in a given node pair belongs to the first node set (232) and a second node in the given node pair belongs to the second node set (234)). Each edge, in the example, thus reflects a relationship, or relationships, between any one node of the first node set (232) and any one node of the second node set (234) (and, by association, any one object of the first object class and any one object of the second object class) directly connected via the edge.

Turning to FIG. 2D, an example multi-partite connected graph (240) is depicted. The multi-partite connected graph (240) includes three (k=3) independent sets of nodes—i.e., a first node set (242), a second node set (244), and a third node set (246). The first node set (242) collectively maps or belongs to a first object class (e.g., documents); the second node set (244) collectively maps or belongs to a second object class (e.g., authors); and the third node set (246) collectively maps or belongs to a third object class (e.g., topics).

Further, in the example, the first node set (242) is denoted by the circles labeled N3, N4, N6, N7, and N9; the second node set (244) is denoted by the circles labeled NO, N2, and N5; and the third node set (246) is denoted by the circles labeled N1 and N8. Each circle, in the first node set (242), subsequently denotes a node that represents or corresponds to a given first object (e.g., a document) in a collection of first objects (e.g., a group of documents) of the first object class (e.g., documents). Meanwhile, each circle, in the second node set (244), subsequently denotes a node that represents or corresponds to a given second object (e.g., an author) in a collection of second objects (e.g., a group of authors) of the second object class (e.g., authors). Lastly, each circle, in the third node set (246), subsequently denotes a node that represents or corresponds to a given third object (e.g., a topic) in a collection of third objects (e.g., a group of topics) of the third object class (e.g., topics).

Moreover, the multi-partite connected graph (240) additionally includes a set of edges (denoted in the example by the lines interconnecting pairs of nodes, where a first node in a given node pair belongs to one object class from the three available object classes, and a second node in the given node pair belongs to another object class from the two remaining object classes (that excludes the one object class to which the first node in the given node pair belongs)). Each edge, in the example, thus reflects a relationship, or relationships, between any one node of one object class (from the three available object classes) and any one node of another object class (from the two remaining object class excluding the one object class) directly connected via the edge.

FIGS. 3A-3D show flowcharts describing a method for insight value assessments using post-insight feedback in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 3A, in Step 300, an insight, an insight lineage graph, and an insight record are obtained. In one or many embodiment(s) disclosed herein, the insight may be defined as a finding (or more broadly, as useful knowledge) gained through data analytics or, more precisely, through the discovery of patterns and/or relationships amongst any given assortment of data/information. The insight lineage graph, on the other hand, may refer to a connected graph (see e.g., FIG. 2A) representative of the insight record (or, more specifically, of a set of insight component records thereof). To that end, an insight lineage graph may include a set of nodes interconnected by a set of edges, where the set of nodes are representative of (and thus map/correspond to) the set of insight component records (described below) and the set of edges are representative of connections or relationships there-between. Further, each node may pertain to a given object (described below) referenced by a given insight component of the insight, where the representative insight component record thereof may store insight component metadata for, or information descriptive of, the given insight component and/or the referenced given object.

Further, in one or many embodiment(s) disclosed herein, the insight record may refer to a portion of an insight catalog particularly dedicated to storing insight metadata, for the insight, and insight component metadata for a set of insight components. The aforementioned insight catalog may represent a data structure configured to maintain insight component metadata that describes one or more creation aspects (also referred to herein as insight component(s)) pertaining to a set of existing insights. Each existing insight, in the set of existing insights, may refer to an insight of which a respective insight creation process has already begun either by an organization user or the insight service. Further, the insight catalog may include, and may thus be organized through, a set of insight records (including the insight record), where each insight record corresponds to a given existing insight (e.g., the insight) in the set of existing insights. Each insight record, moreover, may include (individual) insight metadata (described below) and a set of insight component records, where each insight component record: corresponds to a given insight component, in a set of insight components, associated with a given existing insight to which the insight record corresponds; and stores (individual) insight component metadata (described below) particular to the given insight component to which the insight component record corresponds.

In one or many embodiment(s) disclosed herein, any insight component, associated with any given insight, may reference an object that contributed to the creation of the given insight. Examples of any object that may be referenced by any insight component, associated with any given insight, may include: any structured or unstructured form of information (e.g., tabular data or a dataset, text, a data graphic visualizing tabular data, an image, an audio track, a video clip, etc.); any information processing algorithm (e.g., a machine learning model, a dataset editing algorithm, a text editing algorithm, an image editing algorithm, an audio editing algorithm, a video editing algorithm, etc.) configured to process one or more forms of information; and any other insight (i.e., that is not the given insight with which the insight component is originally associated). Further, any insight component is not limited to the aforementioned specific examples.

Examples of (individual) insight component metadata, respective to any given insight component, may include: a program name associated with any insight editing program within which a creation, importation, editing, and/or processing of an object (described and exemplified above) referenced by the given insight component may be enabled/facilitated; a filename associated with an insight editing file within which the object referenced by the given insight component had been (or is being) created, imported, edited, and/or processed; the object (or a storage location thereof) to which the given insight component references; a context reflecting a usage of the given insight component; if the given insight component references any structured/unstructured form of information—a source of said information, any pipeline(s) used to produce said information, any access permissions associated with said information, a format of said information, a version associated with said information, and a last modified/updated timestamp for said information; if the given insight component references any processing algorithm—a version associated with said algorithm, a source code implementing said algorithm, any dataset(s) used in a training and/or validation of said algorithm (if applicable such as if the algorithm is machine learning based), and one or more authors/creators of said algorithm; and if the given insight component references any other insight—any subset or all of the above examples respective to any information and any algorithms applied thereto that contributed towards producing said other insight. Furthermore, the (individual) insight component metadata, respective to any given insight component, is not limited to the aforementioned specific examples.

Examples of (individual) insight metadata, respective to any given insight, may include: a storage location at which the given insight may be stored; at least a portion of any available insight editing file metadata (e.g., author, creation timestamp, last modified timestamp, etc.) describing the insight editing file within which the given insight had been (or is being) created and/or edited; an insight lineage graph (described below) (or a storage location thereof) associated with the given insight; one or more contexts reflecting a utilization of the given insight; and any user/author metadata (e.g., organization role(s), social network(s), etc.) describing an original creator of the given insight. Further, the (individual) insight metadata, respective to any given insight, is not limited to the aforementioned specific examples.

In Step 302, a digital tracking tag is embedded within the insight (obtained in Step 1200). In one or many embodiment(s) disclosed herein, the digital tracking tag may represent embeddable computer readable program code configured, or directed, to enabling a tracing of any usage of the insight as any asset(s), incorporating the insight (or any variations thereof), is/are ingested and catalogued by the insight service. Further, in embedding the digital tracking tag within the insight, a traceable insight may be obtained.

In Step 304, the insight record (obtained in Step 300) is updated. Specifically, in one or many embodiment(s) disclosed herein, the insight record may be updated to further include a tag identifier (ID) associated with, and there uniquely identifying, the digital tracking tag (embedded in Step 302).

In Step 306, an incorporation of the traceable insight (obtained in Step 302), into a base asset, is detected. In one or many embodiment(s) disclosed herein, the base asset may refer to any first or original asset within which the traceable insight may be incorporated as at least a portion of the asset content presented there-throughout. Further, the base asset may generally refer to any asset originating (e.g., instantiated, or created, and completed) from within (or internal to) an organization-internal environment (see e.g., FIG. 1A) belonging and managed by an organization. Detection of said incorporation of the traceable insight, moreover, may, for example, involve the receiving of telemetry from one or more insight agents (see e.g., FIG. 1B) executing on a client device operated by an organization user whom conducted said incorporation using any insight editing program (described below), where the employed insight editing program may also execute on the aforementioned client device. The insight agent(s), accordingly, may be embedded within, or may otherwise be associated with, the employed insight editing program.

In one or many embodiment(s) disclosed herein, any insight editing program may refer to any software application configured for insight creation and/or editing. Examples of the insight editing program may include, an artificial intelligence and/or machine learning based inference computer program, a text editor, a spreadsheet editor, a presentation editor, an integrated development environment (IDE), an audio editor, a video editor, and an image and/or graphic editor. The insight editing program is not limited to the aforementioned specific examples.

In one or many embodiment(s) disclosed herein, following incorporation of traceable insight within the base asset, and/or following a completion of the base asset, the organization user (responsible for instantiating, or creating, and thus completing the base asset) may opt to store the completed, or an incomplete, base asset on one or more internal and/or external data source(s) (see e.g., FIG. 1A).

In Step 308, the insight record (obtained in Step 300) is updated further. Specifically, in one or many embodiment(s) disclosed herein, the insight record may be updated to further include base asset metadata describing the base asset (mentioned in Step 306). Examples of base asset metadata may include: a filename, or any equivalent identifier, which may uniquely identify the base asset; an author name (or username) associated with an author or creator of the base asset; a creation timestamp encoding a date and/or time at which the base asset had been instantiated or created; and a last modified timestamp encoding a date and/or time at which the base asset had been modified last. Further, the base asset metadata is not limited to the aforementioned specific examples.

In Step 310, and over time, the traceable insight (incorporated in the base asset in Step 306) may be repeatedly re-used, or plagiarized, by other organization user(s) (e.g., whom is/are not the original organization user credited with originally instantiating/creating the insight (obtained in Step 300) from which the traceable insight is derived), as well as by other individual(s) not affiliated with an organization with which at least the original organization user and the other organization user(s) may be associated. Further, any time the traceable insight may be re-used, an original state of the traceable insight may be retained and thus used by a plagiarist. Alternatively, any time the traceable insight may be re-used, a plagiarist may modify (via the application of one or more modifications to) the original state of the traceable insight to obtain a variation of the traceable insight (also referred to herein as a modified traceable insight). Moreover, whether the traceable insight retains its original state or is modified, any re-use (or plagiarism) of the traceable insight may be incorporated into one or more new assets authored/created by any one or more plagiarist(s). The aforementioned new asset(s), subsequently, may encompass at least a new asset subset, in a set of new assets, that may be stored (in a completed or incomplete state) across one or more internal and/or external data sources.

In one or many embodiment(s) disclosed herein, Step 310 may transpire at any time following a storage of the base asset (mentioned in Step 306) across one or more internal and/or external data sources. Further, Step 310 may serve as background filler information describing events, entailing the traceable insight, which may transpire in the background while the disclosed method may be progressing. Accordingly, Step 310 is not representative of an operation that may be performed by the insight service with or without assistance through one or more insight agents.

Returning to the disclosed method, in Step 312, one or more data sources is/are examined. In one or many embodiment(s) disclosed herein, the data source(s) may include one or more internal data sources and/or one or more external data sources. Further, examination of the data source(s) may be a periodic operation, performed by the insight service, in order to periodically update an asset catalog (described below) maintained thereby. Examination of the data source(s) may, subsequently, result in the identification of a set of, or at least one, new asset that has yet to be catalogued by the insight service.

Hereinafter, the remaining steps (e.g., Step 314 through Step 352) may collectively represent an outer iteration, which may be performed sequentially or in parallel for each new asset of the new asset(s) (identified in Step 312).

In Step 314, a/the new asset (identified in Step 312) is ingested. In one or many embodiment(s) disclosed herein, ingestion of a/the new asset may, for example, entail any existing data/content scraping technique(s) through which asset metadata (examples of which are disclosed below), describing a/the new asset, may be extracted, or otherwise obtained, therefrom. Further, ingestion of a/the asset may further result in identifying and/or obtaining asset content (e.g., item(s) of data/information in one or more forms or formats) presented through a/the new asset.

Examples of said asset metadata may include, but is not limited to: a brief description of a/the asset; stewardship (or ownership or authorship) information (e.g., individual or group name(s), contact information, etc.) pertaining to the steward(s)/owner(s)/author(s) of a/the asset; a version character string reflective of a version or state of a/the asset at/for a given point-in-time; one or more categories, topics, and/or aspects associated with a/the asset; an asset identifier uniquely identifying a/the asset; one or more tags, keywords, or terms further describing a/the asset; a source identifier and/or location associated with an internal or external data source (see e.g., FIG. 1A) where a/the asset resides or is maintained; and compliance information specifying laws, regulations, and standards surrounding a/the asset, as well as policies directed to data governance (e.g., availability, usability, integrity, and security) pertinent to a/the asset. The asset metadata for any asset is not limited to the aforementioned specific examples.

Turning to FIG. 3B, in Step 316, an asset catalog is updated using the asset metadata (obtained in Step 314). In one or many embodiment(s) disclosed herein, the asset catalog may refer to a data structure that maintains (aggregated) asset metadata describing a set of assets (e.g., a collection of structured information/content such as tabular data or datasets, and/or of unstructured information/content such as text, videos, images, audio, multimedia, etc.). The asset catalog, further, may organize said (aggregated) asset metadata across a set of asset catalog entries. Each asset catalog entry, in the set of asset catalog entries, may pertain to an asset in the set of assets and, therefore, may store (individual) asset metadata particular to said asset. Accordingly, an updating of the asset catalog, using the asset metadata (obtained in Step 314), may entail: a creation of a new asset catalog entry, in the asset catalog, that may pertain to a/the new asset (identified in Step 312); and a storage of the obtained asset metadata, descriptive of a/the new asset, within the new asset catalog entry.

In Step 318, the asset content (identified/obtained in Step 312) is scanned. In one or many embodiment(s) disclosed herein, scanning of the asset content may employ any existing content scanning technique(s) particularly focused on searching for and identifying any digital tracking tag(s) embedded within any portion(s) of (e.g., one or more items of data/information forming) the asset content.

In Step 320, a determination is made as to whether any (e.g., at least one) digital tracking tag(s) had been discovered based on a scanning (performed in Step 318) of the asset content (identified/obtained in Step 312). In one or many embodiment(s) disclosed herein, if it is determined that at least one digital tracking tag had been discovered, then the method proceeds to Step 322. On the other hand, in one or many other embodiment(s) disclosed herein, if it is determined that zero digital tracking tags had been discovered. Then the method alternatively proceeds to Step 314 (described above—see e.g., FIG. 3A), where another new asset (if any) (identified in Step 312) may be ingested.

Hereinafter, the remaining steps (e.g., Step 322 through Step 352) may collectively represent an inner iteration, which may be performed sequentially or in parallel for each digital tracking tag of the digital tracking tag(s) (discovered through asset content scanning performed in Step 318).

In Step 322, following a determination (made in Step 320) that at least one digital tracking tag had been discovered (based on the scan performed in Step 318), a tag ID is obtained. In one or many embodiment(s) disclosed herein, the tag ID may be associated with, and thus may uniquely identify, a/the digital tracking tag (discovered in Step 318).

In Step 324, a search is performed across the insight catalog (described above—see e.g., Step 300) using the tag ID (obtained in Step 322). In one or many embodiment(s) disclosed herein, the search may be performed in an attempt to identify any insight record, in the set of insight records included in the insight catalog, that stores the tag ID.

In Step 326, a determination is made, based on the search (performed in Step 324), as to whether an insight record had been identified, where the insight record (if identified), and as mentioned above, includes the tag ID used to perform the search. As such, in one or many embodiment(s) disclosed herein, if it is determined that an insight record had been identified, then the method proceeds to Step 328. On the other hand, in one or many other embodiment(s) disclosed herein, if it is alternatively determined that an insight record had not been identified, then the method alternatively proceeds to Step 314 (described above—see e.g., FIG. 3A), where another new asset (if any) (identified in Step 312) may be ingested.

In Step 328, following a determination (made in Step 326) that an insight record, in a set of insight records included in the insight catalog, had been identified based on the search (performed in Step 324), an asset content component is identified from the asset content (identified/obtained in Step 314). In one or many embodiment(s) disclosed herein, the asset content component may refer to an item of data/information (e.g., in the form of any existing structured or unstructured data/information format) of any number of items of data/information collectively forming the asset content. Further, the identified asset content component may be associated, or may be embedded, with a/the digital tracking tag (discovered in Step 318). Moreover, as the tag ID (obtained in Step 322) of a/the digital tracking tag had been determined (via Step 326) to correspond to an identified insight record (and, thus by association, an existing insight respective to the identified insight record), then the identified asset content component may also be identified as a re-used traceable insight derived from or related to the aforementioned existing insight).

In Step 330, one or more bias-removing actions is/are performed, which involve or relate to the re-used traceable insight (identified in Step 328). In one or more embodiment(s) disclosed herein, a bias-removing action may refer to an operation that minimizes, if not eliminates, bias(es) across one or more insight inference models that may be implemented/employed by the insight model. Said bias(es), further, may be caused by any re-used and (re-)ingested insight(s) (e.g., as originally produced or including at least one modification during any re-use(s) thereof) that the insight service is unaware is/are insight(s) derived or inferred through one or more capabilities (or functionalities) of the insight service itself. Examples of the bias-removing action(s) may include: identifying said previously produced insight(s) (e.g., the re-used traceable insight) and omitting the identified previously produced insight(s) from the training dataset(s) employed in a training of prospective insight generating model(s) (e.g., machine learning model(s)) as well as from the inferencing dataset(s) processed by said prospective insight generating model(s) leading to the inference of prospective insight(s); and utilizing any existing causal inference framework(s) to verify whether the re-used traceable insight causes bias, and if so, omitting the re-used traceable insight, as described above, from future insight generation processes. Moreover, any bias-removing action(s) is/are not limited to the aforementioned specific examples.

Turning to FIG. 3C, in Step 332, an (existing) insight is obtained. In one or many embodiment(s) disclosed herein, the (existing) insight may correspond to the insight record (identified by the search performed in Step 324).

In Step 334, one or differentiation algorithm(s) is/are applied to, or between, the insight (obtained in Step 332) and the re-used traceable insight (identified in Step 328). In one or many embodiment(s) disclosed herein, any differentiation algorithm may refer to a process, a model, a set of rules, etc. configured to examine/analyze two items of data/information, of a same/common form or format, and identify any difference(s) differentiating said two items of data/information. Examples of said applied differentiating algorithm(s) may include: (a) for text formatted items of data/information—a Myers O(ND) Diff algorithm; (b) for image/graphic formatted items of data/information—a Scale Invariant Feature Transform (SIFT) algorithm; and (c) for video formatted items—a frame-by-frame comparison algorithm. Further any applied differentiation algorithm(s) is/are not limited to the aforementioned specific examples. Any difference(s) (if identified), moreover, may correspond to any modification(s) applied to the insight to derive the re-used traceable insight.

In Step 336, a determination is made as to whether any (e.g., at least one) difference(s) had been identified between the insight (obtained in Step 332) and the re-used traceable insight (identified in Step 328) based on the differentiation algorithm(s) (applied thereto in Step 334). In one or many embodiment(s) disclosed herein, if it is determined that at least one difference had been identified, then the method proceeds to Step 338. On the other hand, in one or many other embodiment(s) disclosed herein, if it is alternatively determined that zero differences had been identified, then the method alternatively proceeds to Step 314 (described above—see e.g., FIG. 3A), where another new asset (if any) (identified in Step 312) may be ingested.

In Step 338, following the determination (made in Step 336) that at least one difference had been identified between the insight (obtained in Step 332) and the re-used traceable insight (identified in Step 328) based on the differentiation algorithm(s) (applied thereto in Step 334), authorship information, for a/the new asset (identified in Step 312), is examined. In one or many embodiment(s) disclosed herein, the authorship information may be included in, and thus may be extracted from, the asset metadata (obtained in Step 314) respective to a/the new asset. Further, the authorship information may encompass metadata particular to an author, or authors, (e.g., creator(s)) of a/the new asset.

In Step 340, a determination is made, based on the examination (performed in Step 338) of the authorship information for a/the new asset (identified in Step 312), as to whether said authorship information includes at least one contact email address. In one or more embodiment(s) disclosed herein, if it is determined that said authorship information includes at least one contact email address, for contacting an author, or authors, of a/the new asset, then the method proceeds to Step 342. On the other hand, in one or many other embodiment(s) disclosed herein, if it is alternatively determined that said authorship information includes zero contact email addresses, then the method alternatively proceeds to Step 314 (described above—see e.g., FIG. 3A), where another new asset (if any) (identified in Step 312) may be ingested.

In Step 342, following the determination (made in Step 340), based on the examination (performed in Step 338) of authorship information for a/the new asset (identified in 1212), that said authorship information includes at least one contact email address for contacting the author, or authors, of a/the new asset, an insight modification questionnaire is created. In one or many embodiment(s) disclosed herein, the insight modification questionnaire may refer to an electronic document specifying or including a set of questions centered on difference(s) (identified in Step 334) (or modification(s)) differentiating the re-used traceable insight (identified in Step 328) from the insight (obtained in Step 332). By way of an example, the set of questions may inquire what/which modification(s) had been applied to the insight to derive the re-used traceable insight, how the modification(s) were applied, and why the modification(s) were applied. Further, though centered on the identified difference(s) or modification(s), at least a portion of the set of questions may inquire about author metadata (e.g., organization role(s), affiliated organization(s), domain expertise(s), etc.) descriptive of the author(s) of a/the new asset. The set of questions, moreover, is/are not limited to the aforementioned specific examples.

In Step 344, an insight modification email is created. In one or many embodiment(s) disclosed herein, the insight modification email may represent an electronic mail message that includes either the insight modification questionnaire (created in Step 342) or a web address (or link) (e.g., a uniform resource locator (URL)) referencing, or otherwise pointing to, a storage location where the insight modification questionnaire may be stored/located (and, subsequently, accessed).

In Step 346, the insight modification email (created in Step 344) is transmitted to each contact email address of the at least one contact email address (identified via examination of the authorship information in Step 338).

Turning to FIG. 3D, in Step 348, following a choosing of the author(s) of a/the new asset (identified in Step 312) to address at least a portion of the insight modification questionnaire (transmitted via email in Step 346), an insight modification questionnaire response is received therefrom. In one or many embodiment(s) disclosed herein, the insight modification questionnaire response may represent a returned insight modification questionnaire that specifies or includes a respective answer, by said author(s), for at least one question, in the set of questions, outlined in the insight modification questionnaire.

In Step 350, the insight modification questionnaire response (received in Step 348) is ingested. In one or many embodiment(s) disclosed herein, ingestion of insight modification questionnaire response may, for example, entail any existing data/content scraping technique(s) through which insight modification information may be extracted, or otherwise obtained, therefrom. By way of an example, the insight modification information may include a justification statement elaborating on (or providing reasoning behind) the modification(s) applied to the insight (obtained in Step 332) to derive the re-used traceable insight (identified in Step 328). Further, the insight modification information is not limited to the aforementioned specific example.

In Step 352, an insight value, of/for the insight (obtained in Step 332), is assessed. In one or many embodiment(s) disclosed herein, the insight value may reflect or measure a significance, worth, or usefulness of the insight at any point-in time. Assessment of the insight value, of/for the insight, may account for any number of factors, including, but not limited to: the insight modification information (obtained in Step 350); an insight re-use count representing a tracked metric that reflects a number of times the insight has been re-used (or plagiarized) within a same context (or a different context) as an original context reflecting a utilization for/of the insight and/or the base asset (mentioned in Step 306) in which the insight had originally been embedded; and an original author, or authors, (e.g., creator(s)) (or more specifically, author metadata (e.g., organization role(s), domain expertise(s), etc.) describing said original author(s)) of the insight.

In one or many embodiment(s) disclosed herein, assessment of the insight value, of/for the insight, may lead to a computation or quantification thereof. For example, after an insight is created and published (e.g., stored across one or more internal and/or external data sources), an executive of an organization takes it and uses in it a keynote at a large conference, then the insight value of the insight goes up. If the impact score of a new asset goes up, likewise so does the insight value of the insight re-used therein.

As the insight value increases, the insight will show up higher in searches based on simple page rank algorithm. Because of this, the insight will be protected more within the scope of the infrastructure, meaning more snapshots of the data and models are needed to verify the insight and make sure no data, model, or the insight itself is lost. Many traditional infrastructure techniques can be used here. Each has a cost associated to it, so the insight value has to remain above the cost otherwise the insight will be moved to a cheaper infrastructure technique, or one that is not as fault tolerant. Also the number of copies of the insight being cached throughout the system will be reduced.

Once the insight value is reduced the amount of re-calculations or re-training will be reduced as well. Once the insight value has been low for a period of time then the insight may be archived. The insight will never be fully removed as the whole premise of the system is to utilize historical data. Some insights could also be considered predictions that need to be kept to verify how close the prediction is or was. In this case, a prediction from 10 years ago might still be relevant depending on time period of the prediction. In other cases, this period would have long expired and the insight value of the insight may be at its lowest point. But even then, the insight may be needed to help train the next set of algorithms and models as a labeled dataset.

FIG. 4 shows an example computing system in accordance with one or more embodiments disclosed herein. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one embodiment disclosed herein, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments disclosed herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments disclosed herein.

FIGS. 5A-5P show an example scenario in accordance with one or more embodiments disclosed herein. The example scenario, illustrated through FIGS. 5A-5P and described below, is for explanatory purposes only and not intended to limit the scope disclosed herein.

Hereinafter, consider the following example scenario whereby the insight service seeks to minimize, if not eliminate, bias across one or more insight inference models implemented/employed thereby that may be caused by any re-used and (re-)ingested insight(s) (e.g., as originally produced or including at least one modification during any re-use(s) thereof) that the insight service is unaware is/are insight(s) derived or inferred through one or more capabilities (or functionalities) of the insight service. In the following example scenario, the insight service further seeks to evaluate an insight value for any insight(s) derived or inferred thereby. To achieve these ends, the insight service relies on its disclosed capability of insight value assessments using post-insight feedback.

Further, interactions amongst various actors—e.g., an Insight Agent executing on a Client Device A (500) operated by an organization user identified as Ben, a Client Device B (502) (without an Insight Agent) operated by another organization user identified as Pete, the Insight Service (504), and a Data Source (506)—are illustrated in conjunction with components shown across FIGS. 5A-5P and described (in an itemized manner) below. Said interactions, as well as processes performed on/by any particular actor may follow embodiments disclosed herein pertaining to insight value assessments using post-insight feedback as applied to the circumstances of the example scenario.

### Turning to FIG. 5A:

1. User Ben, operating Client Device A, creates an insight (e.g., forecast data) through a series of insight creation actions, where said series of insight creation actions are captured by the Insight Agent on Client Device A (500)
2. The Insight Agent on Client Device A (500) submits the series of insight creation actions, as well as the insight, to the Insight Service (504)

### Turning to FIG. 5B:

3. Based on at least the series of insight creation actions, the Insight Service (504) creates and maintains an insight lineage graph and an insight record both for the insight, where the insight record resides in an insight catalog and at least includes: an insight storage location at where the insight is stored, an insight lineage graph storage location at where the insight lineage graph is stored, and insight creation metadata mapped to the insight lineage graph and describing creation aspects pertaining to the insight based on the series of insight creation actions
4. The Insight Service (504) creates a digital tracking tag to facilitate tracking of the insight, where the digital tracking tag is represented by embeddable computer readable program code

### Turning to FIG. 5C:

5. The Insight Service (504) creates/identifies a tag identifier (ID) associated with the digital tracking tag and, subsequently, updates the insight record for the insight to further include the tag ID
6. The Insight Service (504) relays the digital tracking tag to the Insight Agent on Client Device A (500)
7. Upon receiving the digital tracking tag, the Insight Agent on Client Device A (500) embeds the digital tracking tag within the insight (locally available on Client Device A) to obtain a traceable insight

### Turning to FIG. 5D:

8. User Ben, operating Client Device A, opts to incorporate the traceable insight within a base asset (e.g., a presentation slide file/document), where said incorporation of the traceable insight is detected by the Insight Agent on Client Device A (500)
9. The Insight Agent on Client Device A (500) thereafter captures base asset metadata (e.g., author, creation timestamp, last modified timestamp, etc.) describing the base asset
A. The Insight Agent on Client Device A (500) relays the base asset metadata to the Insight Service (504)

### Turning to FIG. 5E:

B. The Insight Service (504) updates the insight record for the insight to further include the base asset metadata received from the Insight Agent on Client Device A (500)
C. User Ben, operating Client Device A, meanwhile, chooses to store the base asset, including the traceable insight, on the Data Source (506)
D. At some future point-in-time, User Pete, operating Client Device B (502), finds and downloads the base asset, stored on the Data Source (506), therefrom, where User Pete intends to re-use the traceable insight incorporated within the base asset

### Turning to FIG. 5F:

E. Once the base asset is downloaded onto Client Device B (502), User Pete extracts the traceable insight from the base asset
F. Afterwards, User Pete, operating Client Device B (502), modifies (e.g., applies a modification to) the traceable insight, thereby obtaining a modified traceable insight

### Turning to FIG. 5G:

G. User Pete, operating Client Device B (502), subsequently incorporates the modified traceable insight within a new asset (e.g., a predominantly text based document)
H. User Pete, operating Client Device B (502) then stores the new asset, including the re-used traceable insight, on the Data Source (506)
I. As is performed periodically, the Insight Service (504) examines the Data Source (506) for any yet to be ingested and/or catalogued asset(s) stored thereon

### Turning to FIG. 5H:

J. Based on the examination of the Data Source (506), the Insight Service (504) identifies and ingests the new asset stored thereon earlier by User Pete
K. Through ingestion of the new asset, the Insight Service (504) obtains asset metadata describing the new asset, as well as asset content collectively representing any item(s) of data/information presented in the new asset
L. The Insight Service (504) updates an asset catalog using the asset metadata or, more specifically, creates a new asset catalog entry in the asset catalog, where the new asset catalog entry corresponds to the new asset and includes the asset metadata

### Turning to FIG. 5I:

M. Thereafter, the Insight Service (504) scans the asset content for, and thus discovers, a digital tracking tag embedded within an asset content component (e.g., an item of data/information presented in the new asset)
N. Through examination of the digital tracking tag, the Insight Service (504) obtains a tag ID associated therewith

### Turning to FIG. 5J:

O. Using the tag ID, the Insight Service (504) then searches the insight catalog for, and thus identifies, the insight record for the insight, where the insight record includes the tag ID
P. Based on the identification of the insight record, the Insight Service (504) further identifies the asset content component (e.g., the modified traceable insight), embedded with the discovered digital tracking tag, as a re-used traceable insight that is derived from the insight corresponding to the insight record

### Turning to FIG. 5K:

Q. The Insight Service (504) performs at least one bias-removing action involving or related to the re-used traceable insight
R. The Insight Service (504) obtains the insight corresponding to the insight record by, for example, using an insight storage location included in the insight record to retrieve the insight from a storage location referenced by the insight storage location

### Turning to FIG. 5L:

S. In applying a differentiation algorithm to or between the insight and the re-used traceable insight, the Insight Service (504) identifies a difference there-between, where the difference corresponds to the modification applied to the traceable insight earlier by User Pete

### Turning to FIG. 5M:

T. In response to identifying the difference (or modification), the Insight Service (504) examines the asset metadata (e.g., more specifically, stewardship, ownership, or authorship information therein) for the new asset, which is maintained in the asset catalog, to identify contact information (or, more specifically, a contact email address) associated with a steward, owner, or author (e.g., User Pete) of the new asset

### Turning to FIG. 5N:

U. In identifying the contact email address, the Insight Service (504) creates an insight modification questionnaire concerning the re-used traceable insight and, more specifically, the modification differentiating the re-used traceable insight against the insight
V. The Insight Service (504) creates an email that addresses the contact email address for User Pete, and includes the insight modification questionnaire or, alternatively, a web address/link referencing the insight modification questionnaire

### Turning to FIG. 5O:

W. The Insight Service (504) transmits the email to User Pete via the contact email address
X. Upon receiving the email, including the insight modification questionnaire (or the web address/link referencing the same), User Pete, operating Client Device B (502), opts to create an insight modification questionnaire response addressing at least a portion of the insight modification questionnaire
Y. After its completion, User Pete, operating Client Device B (502), submits the insight modification questionnaire response to the Insight Service (504)

### Turning to FIG. 5P:

Z. Once received, the Insight Service (504) ingests the insight modification questionnaire response to obtain insight modification information, where the insight modification information includes a justification statement for applying the modification
a. Based on at least the insight modification information, the Insight Service (504) assesses an insight value of/for the insight

While the embodiments disclosed herein have been described with respect to a limited number of embodiments, those skilled in the art, having benefit of this disclosure, will appreciate that other embodiments can be devised which do not depart from the scope disclosed herein as disclosed herein. Accordingly, the scope disclosed herein should be limited only by the attached claims.

What is claimed is:

1. A method for assessing insight values, the method comprising:
examining a data source to identify a new asset from a collection of assets maintained on the data source;
ingesting the new asset to obtain an asset content of the new asset;
identifying, from the asset content, an asset content component comprising a digital tracking tag;
identifying an insight based on the digital tracking tag,
wherein the asset content component represents a re-used traceable insight derived from the insight;
making a determination that the re-used traceable insight comprises a modification that had been applied to the insight during a re-use of the insight;
contacting, based on the determination, an author of the new asset to obtain insight modification information concerning the modification; and
assessing an insight value of the insight at least based on the insight modification information.

2. The method of claim 1, wherein the insight modification information comprises a justification statement for applying the modification.

3. The method of claim 1, wherein assessing the insight value of the insight is further based on an insight re-use count associated with the insight.

4. The method of claim 1, the method further comprising:
prior to making the determination:
performing a bias-removing action involving the re-used traceable insight.

5. The method of claim 1, wherein identifying the insight based on the digital tracking tag, comprises:
searching, using a tag identifier (ID) associated with the digital tracking tag, an insight catalog comprising a set of insight records; and
identifying, from the set of insight records, an insight record comprising the tag ID,
wherein the insight record corresponds to the insight.

6. The method of claim 5, wherein the insight record further comprises an insight storage location referencing where the insight is stored, an insight lineage graph storage location referencing where an insight lineage graph for the insight is stored, and insight creation metadata mapped to the insight lineage graph.

7. The method of claim 1, wherein ingesting the new asset further obtains asset metadata describing the new asset, and the method further comprises:
prior to identifying the asset content component:
updating, using the asset metadata, an asset catalog comprising a set of asset catalog entries,
wherein the asset metadata is stored in an asset catalog entry, in the set of asset catalog entries, corresponding to the new asset.

8. The method of claim 7, the method further comprising:
prior to contacting the author of the new asset:
extracting authorship information from the asset metadata;
making a second determination that the authorship information comprises a contact email address for the author of the new asset;
based on the second determination:
creating an insight modification questionnaire centered on the modification;
creating an email comprising one selected from a group comprising the insight modification questionnaire and a web address referencing the insight modification questionnaire;
transmitting, using the contact email address, the email to the author of the new asset;
receiving, from the author of the new asset, an insight modification questionnaire response addressing the insight modification questionnaire; and
ingesting the insight modification questionnaire response to obtain the insight modification information.

9. The method of claim 1, the method further comprising:
prior to examining the data source:
obtaining the insight through a creation thereof by one selected from a group comprising an organization user and an insight service;
embedding the digital tracking tag within the insight to obtain a traceable insight; and
detecting an incorporation of the traceable insight in a base asset,
wherein the base asset is subsequently stored in the data source.

10. The method of claim 9, wherein the re-use of the insight, comprises:
an obtaining, by the author of the new asset, of the base asset from the data source;
an extracting, by the author of the new asset, of the traceable insight from the base asset;
an applying, by the author of the new asset, of the modification to the traceable insight to derive the re-used traceable insight;
an incorporating, by the author of the new asset, of the re-used traceable insight as at least a portion of the asset content in the new asset; and
a storing, by the author of the new asset, of the new asset in the data source.

11. A non-transitory computer readable medium (CRM) comprising computer readable program code, which when executed by a computer processor, enables the computer processor to perform a method for assessing insight values, the method comprising:
examining a data source to identify a new asset from a collection of assets maintained on the data source;
ingesting the new asset to obtain an asset content of the new asset;
identifying, from the asset content, an asset content component comprising a digital tracking tag;
identifying an insight based on the digital tracking tag,
wherein the asset content component represents a re-used traceable insight derived from the insight;
making a determination that the re-used traceable insight comprises a modification that had been applied to the insight during a re-use of the insight;
contacting, based on the determination, an author of the new asset to obtain insight modification information concerning the modification; and
assessing an insight value of the insight at least based on the insight modification information.

12. The non-transitory CRM of claim 11, wherein the insight modification information comprises a justification statement for applying the modification.

13. The non-transitory CRM of claim 11, wherein assessing the insight value of the insight is further based on an insight re-use count associated with the insight.

14. The non-transitory CRM of claim 11, the method further comprising:
prior to making the determination:
performing a bias-removing action involving the re-used traceable insight.

15. The non-transitory CRM of claim 11, wherein identifying the insight based on the digital tracking tag, comprises:
searching, using a tag identifier (ID) associated with the digital tracking tag, an insight catalog comprising a set of insight records; and
identifying, from the set of insight records, an insight record comprising the tag ID,
wherein the insight record corresponds to the insight.

16. The non-transitory CRM of claim 11, wherein ingesting the new asset further obtains asset metadata describing the new asset, and the method further comprises:
prior to identifying the asset content component:
updating, using the asset metadata, an asset catalog comprising a set of asset catalog entries,
wherein the asset metadata is stored in an asset catalog entry, in the set of asset catalog entries, corresponding to the new asset.

17. The non-transitory CRM of claim 16, the method further comprising:
prior to contacting the author of the new asset:
extracting authorship information from the asset metadata;
making a second determination that the authorship information comprises a contact email address for the author of the new asset;
based on the second determination:
creating an insight modification questionnaire centered on the modification;
creating an email comprising one selected from a group comprising the insight modification questionnaire and a web address referencing the insight modification questionnaire;
transmitting, using the contact email address, the email to the author of the new asset;
receiving, from the author of the new asset, an insight modification questionnaire response addressing the insight modification questionnaire; and
ingesting the insight modification questionnaire response to obtain the insight modification information.

18. The non-transitory CRM of claim 11, the method further comprising:
prior to examining the data source:
obtaining the insight through a creation thereof by one selected from a group comprising an organization user and an insight service;
embedding the digital tracking tag within the insight to obtain a traceable insight; and
detecting an incorporation of the traceable insight in a base asset,
wherein the base asset is subsequently stored in the data source.

19. The non-transitory CRM of claim 18, wherein the re-use of the insight, comprises:
an obtaining, by the author of the new asset, of the base asset from the data source;
an extracting, by the author of the new asset, of the traceable insight from the base asset;
an applying, by the author of the new asset, of the modification to the traceable insight to derive the re-used traceable insight;
an incorporating, by the author of the new asset, of the re-used traceable insight as at least a portion of the asset content in the new asset; and
a storing, by the author of the new asset, of the new asset in the data source.

20. A system, the system comprising:
an insight service comprising a computer processor configured to perform a method assessing insight values, the method comprising:
examining a data source to identify a new asset from a collection of assets maintained on the data source;
ingesting the new asset to obtain an asset content of the new asset;
identifying, from the asset content, an asset content component comprising a digital tracking tag;
identifying an insight based on the digital tracking tag,
wherein the asset content component represents a re-used traceable insight derived from the insight;
making a determination that the re-used traceable insight comprises a modification that had been applied to the insight during a re-use of the insight;
contacting, based on the determination, an author of the new asset to obtain insight modification information concerning the modification; and
assessing an insight value of the insight at least based on the insight modification information.
